(19) United States
(12) Patent Application Publication
(10) Pub. No.: US 2015/0068260 A1
(43) Pub. Date: Mar. 12, 2015

(54) METHOD OF SOLID-LIQUID SEPARATION AND USES THEREOF

(71) Applicants: Andrew James Alexander Volk, Edmonton (CA); Trevor Jason Nickel, Edmonton (CA)

(72) Inventors: Andrew James Alexander Volk, Edmonton (CA); Trevor Jason Nickel, Edmonton (CA)

(21) Appl. No.: 14/539,228

(22) Filed: Nov. 12, 2014

Related U.S. Application Data
(63) Continuation of application No. PCT/CA2013/050460, filed on Jun. 14, 2013.
(60) Provisional application No. 61/659,506, filed on Jun. 14, 2012.

(51) Int. Cl. C05B 17/00; C10G 1/04

(52) U.S. Cl. CPC C05B 17/00; C10G 1/045
USPC 71/64.01; 208/390

(57) ABSTRACT

The invention provides a method for enhancing solid-liquid separation by using a low molecular weight alcohol, such as isopropanol. The methods can be used in a variety of settings to facilitate solid-liquid separation, such as that in anaerobic digestion and treatment of tailing pond sludge.

### REFERENCE TO RELATED APPLICATIONS

This application is a continuation application of International Application No. PCT/CA2013/050460, filed Jun. 14, 2013; which claims the benefit of the filing date of U.S. Provisional Application No. 61/659,506, filed on Jun. 14, 2012, the entire content of each of which is incorporated herein by reference.

### BACKGROUND OF THE INVENTION

Solid-liquid separation has extensive utility in various industrial and agricultural settings. For instance, with the rapid expansion of intensive livestock operation worldwide, and with the increasing demand of renewable energy production from biomass, large-scale anaerobic digestion of what were formerly considered “bio-waste materials” (such as animal manure) for biogas production has gained much attention, due to the potential economic and environmental benefits. Anaerobic digestion produces methane rich biogas, as well as a digested effluent (also known as anaerobic digestate) containing significant amounts of various nutrients, including nitrogen, phosphorus, and other plant nutrients. These nutrients are valuable for plant growth, however, nutrient concentration in the digestate may be relatively low compared to commercial fertilizers. Currently, the only practically feasible option for managing digestate is direct application to land. Due to the low concentration of nutrients, the relative cost of transportation can be high, limiting economic value of digestate. Stockpiling of digestate may occur as a result, meaning that nutrients contained therein may pose potential environmental risk to the surrounding water bodies if improperly managed. More effective separation of liquids from solids in digestate would allow for increased saleability of these products and their derivatives, and thus a much lowered environmental risk.

In another example, oil sands extraction is generally held to be more environmentally damaging than conventional crude oil. It can affect the land when the bitumen is initially mined, water by its requirement of large quantities of water during separation of the oil and sand and the air due to the release of carbon dioxide and other emissions. Heavy metals, including lead, mercury, arsenic and copper naturally present in oil sands, may be concentrated by the extraction process.

A large part of oil sands mining operations involves clearing trees and brush from a site and removing the overburden—topsoil, muskeg, sand, clay and gravel—that sits atop the oil sands deposit. In Canada, as a condition of licensing, projects are required to implement a reclamation plan. The mining industry asserts that the boreal forest will eventually colonize the reclaimed lands, but their operations are massive and work on long-term timeframes.

Meanwhile, the Energy Resources Conservation Board of Alberta (ERCB/Board) has approved Directive 074 which sets forth new requirements for the regulation of tailings operations associated with mineable oil sands. Specifically, specific capture rates of the fines must be by 20% by Jun. 30, 2011; 30% by Jun. 30, 2012, and 50% by Jun. 30, 2013.

Between 2 to 4.5 volume units of water are used to produce each volume unit of synthetic crude oil in an ex-situ mining operation. According to Greenpeace, the Canadian oil sands operations use 349 million cubic meters per annum (12.3×10⁹ cu ft/a) of water, twice the amount of water used by the city of Calgary. Despite recycling, almost all of it ends up in tailings ponds. As of 2007, tailing ponds in Canada covered an area of approximately 50 square kilometers (19 sq mi). The ERCB estimates that current tailings volumes on the landscape total about 720 million cubic meters. In one study, the volume of tailings is expected to grow from 843 million cubic meters in 2010 to over 1.1 billion cubic meters in 2020, an increase of 30%, and the volume of tailings will still be over 1.1 billion cubic meters in 2065.

Oil sands tailings are a mixture of water, clay, sand and residual hydrocarbons produced during the mine extraction process. Oil sand tailings are generated from hydrocarbon extraction process operations that separate the valuable hydrocarbons from oil sand ore. All commercial hydrocarbon extraction processes use variations of the Clark Hot Water Process, in which water is added to the oil sands to enable the separation of the valuable hydrocarbon fraction from the oil sand minerals. The process water also acts as a carrier fluid for the mineral fraction. Once the hydrocarbon fraction is recovered, the residual water, unrecovered hydrocarbons and minerals are generally referred to as “tailings.”

The oil sand industry has adopted a convention with respect to mineral particle sizing. Mineral fractions with a particle diameter greater than 44 microns are referred to as “sand.” Mineral fractions with a particle diameter less than 44 microns are referred to as “fines.” Mineral fractions with a particle diameter less than 2 microns are generally referred to as “clay,” but in some instances “clay” may refer to the actual particle mineralogy. The relationship between sand and fines in tailings reflects the variation in the oil sand ore make-up, the chemistry of the process water and the extraction process.

Conventionally, tailings are transported to a deposition site generally referred to as a “tailings pond” located close to the oil sands mining and extraction facilities to facilitate pipeline transportation, discharging and management of the tailings. Due to the scale of operations, oil sand tailings ponds cover vast tracts of land and must be constructed and managed in accordance with regulations. The management of pond location, filling, level control and reclamation is a complex undertaking given the geographical, technical, regulatory and economic constraints of oil sands operations.

Each tailings pond is contained within a dyke structure generally constructed by placing the sand fraction of the tailings within cells or on beaches. The process water, unrecovered hydrocarbons, together with sand and fine minerals not trapped in the dyke structure flow into the tailings pond. Tailings streams initially discharged into the ponds may have fairly low densities and solids contents, for instance around 0.5-10 wt %.

In the tailings pond, the process water, unrecovered hydrocarbons and minerals settle naturally to form different strata. The upper stratum is primarily water that may be recycled as process water to the extraction process. The lower stratum contains settled residual hydrocarbon and minerals which are predominately fines. This lower stratum is often referred to as “mature fine tailings” (MFT). Mature fine tailings have very slow consolidation rates and represent a major challenge to tailings management in the oil sands industry. MFT is comprised of about 70% water and 30% fine clay. Left on its own, the MFT could take centuries to solidify.

The composition of mature fine tailings is highly variable. Near the top of the stratum the mineral content is about 10 wt % and through time consolidates up to 50 wt % at the bottom of the stratum. Overall, mature fine tailings have an average mineral content of about 30 wt %. While fines are the dominant particle size fraction in the mineral content, the sand content may be 15 wt % of the solids and the clay content may be up to 75 wt % of the solids, reflecting the oil sand ore and extraction process. Additional variation may result from the residual hydrocarbon which may be dispersed in the mineral or may segregate into mat layers of hydrocarbon. The mature fine tailings in a pond not only has a wide variation of compositions distributed from top to bottom of the pond but there may also be pockets of different compositions at random locations throughout the pond.

Mature fine tailings behave as a fluid-like colloidal material. The fact that mature fine tailings behave as a fluid significantly limits options to reclaim tailings ponds. In addition, mature fine tailings do not behave as a Newtonian fluid, which makes continuous commercial scale treatments for dewatering the tailings all the more challenging. Without dewatering or solidifying the mature fine tailings, tailings ponds have increasing economic and environmental implications over time.

There are some methods that have been proposed for disposing of or reclaiming oil sand tailings by attempting to solidify or dewater mature fine tailings. If mature fine tailings can be sufficiently dewatered so as to convert the waste product into a reclaimed firm terrain, then many of the problems associated with this material can be curtailed or completely avoided. As a general guideline target, achieving a solids content of >55 wt % for mature fine tailings is considered sufficiently “dried” for reclamation.

One known method for dewatering MFT involves a freeze-thaw approach. Several field trials were conducted at oil sands sites by depositing MFT into small, shallow pits that were allowed to freeze over the winter and undergo thawing and evaporative dewatering the following summer. Scale up of such a method would require enormous surface areas and would be highly dependent on weather and season. Furthermore, other restrictions of this setup were the collection of release water and precipitation on the surface of the MFT which discounted the efficacy of the evaporative drying mechanism.

Some other known methods have attempted to treat MFT with the addition of a chemical to create a thickened paste that will solidify or eventually dewater.

One such method, referred to as “consolidated tailings” (CT), involves combining mature fine tailings with sand and gypsum. A typical consolidated tailings mixture is about 60 wt % mineral (balance is process water) with a sand to fines ratio of about 4 to 1, and 600 to 1000 ppm of gypsum. This combination can result in a non-segregating mixture when deposited into the tailings ponds for consolidation. However, the CT method has a number of drawbacks. It relies on continuous extraction operations for a supply of sand, gypsum and process water. The blend must be tightly controlled. Also, when consolidated tailings mixtures are less than 60 wt % mineral, the material segregates with a portion of the fines returned to the pond for reprocessing when settled as mature fine tailings. Furthermore, the geotechnical strength of the deposited consolidated tailings requires containment dykes and, therefore, the sand required in CT competes with sand used for dyke construction until extraction operations cease. Without sand, the CT method cannot treat mature fine tailings. In addition, gypsum cannot be recovered and reused in the process.

Another method conducted at lab-scale sought to dilute MFT preferably to 10 wt % solids before adding Percol LT27A or 156. Though the more diluted MFT showed faster settling rates and resulted in a thickened paste, this dilution-dependent small batch method could not achieve the required dewatering results for reclamation of mature fine tailings.

Some other methods have attempted to use polymers or other chemicals to help dewater MFT. However, these methods have encountered various problems and have been unable to achieve reliable results. When generally considering methods comprising chemical addition followed by tailings deposition for dewatering, there are a number of important factors that should not be overlooked.

One factor is the nature, properties and effects of the added chemicals. The chemicals that have shown promise up to now have been dependent on oil sand extraction by-products, effective only at lab-scale or within narrow process operating windows, or unable to properly and reliably mix, react or be transported with tailings. Some added chemicals have enabled thickening of the tailings with no change in solids content by entrapping water within the material, which limits the water recovery options from the deposited material. Some chemical additives such as gypsum and hydrated lime have generated water runoff that can adversely impact the process water reused in the extraction processes or dried tailings with a high salt content that is unsuitable for reclamation.

Another factor is the chemical addition technique. Known techniques of adding sand or chemicals often involve blending materials in a tank or thickener apparatus. Such known techniques have several disadvantages including requiring a controlled, homogeneous mixing of the additive in a stream with varying composition and flows which results in inefficiency and restricts operational flexibility. Some chemical additives also have a certain degree of fragility, changeability or reactivity that requires special care in their application.

Another factor is that many chemical additives can be very viscous and may exhibit non-Newtonian fluid behavior. Several known techniques rely on dilution so that the combined fluid can be approximated as a Newtonian fluid with respect to mixing and hydraulic processes. Mature fine tailings, however, particularly at high mineral or clay concentrations, demonstrates non-Newtonian fluid behavior. Consequently, even though a chemical additive may show promise as a dewatering agent in the lab or small scale batch trials, it is difficult to repeat performance in an up-scaled or commercial facility. This problem was demonstrated when attempting to inject a viscous polymer additive into a pipe carrying MFT. The main MFT pipeline was intersected by a smaller side branch pipe for injecting the polymer additive. For Newtonian fluids, one would expect this arrangement to allow high turbulence to aid mixing. However, for the two non-Newtonian fluids, the field performance with this mixing arrangement was inconsistent and inadequate. There are various reasons why such mixing arrangements encounter problems. When the additive is injected in such a way, it may have a tendency to congregate at the top or bottom of the MFT stream depending on its density relative to MFT and the injection direction relative to the flow direction. For non-Newtonian fluids, such as Bingham fluids, the fluid essentially flows as a plug down the pipe with low internal turbulence in the region of the plug. Also, when the chemical additive reacts quickly with the MFT, a thin reacted region may form on the outside of the additive plug thus separating unreacted chemical additive and unreacted MFT.

Inadequate mixing can greatly decrease the efficiency of the chemical additive and even short-circuit the entire dewatering process. Inadequate mixing also results in inefficient use of the chemical additives, some of which remain unmixed and unreacted and cannot be recovered. Known techniques have several disadvantages including the inability to achieve a controlled, reliable or adequate mixing of the chemical additive as well as poor efficiency and flexibility of the process.

Still another factor is the technique of handling the oil sand tailings after chemical addition. If oil sand tailings are not handled properly, dewatering may be decreased or altogether prevented. In some past trials, handling was not managed or controlled and resulted in unreliable dewatering performance. Some techniques such as in CIBA's Canadian patent application No. 2,512,324 (Schaffer et al.) have attempted to simply inject the chemical into the pipeline without a methodology to reliably adapt to changing oil sand tailings compositions, flow rates, hydraulic properties or the nature of particular chemical additive. Relying solely on this ignores the complex nature of mixing and treating oil sand tailings and hampers the flexibility and reliability of the system. When the chemical addition and subsequent handling have been approached in such an uncontrolled, trial-and-error fashion, the dewatering performance has been unachievable.

In 2009, Suncor announced it was seeking government approval for a new process to recover tailings called Tailings Reduction Operations, which accelerates the settling of fine clay, sand, water, and residual bitumen in ponds after oil sands extraction. The technology involves dredging mature tailings from a pond bottom, mixing the suspension with a polymer flocculent, and spreading the sludge-like mixture over a “beach” with a shallow grade. According to the company, the process could reduce the time for water reclamation from tailings to weeks rather than years, with the recovered water being recycled into the oil sands plant. In addition to reducing the number of tailing ponds, Suncor claims that the process could reduce the time to reclaim a tailing pond from 40 years at present to 7-10 years, with land rehabilitation continuously following 7 to 10 years behind the mining operations.

However, the polymers used may not be recovered and reused in the process. Furthermore, given the significant inventory and ongoing production of MFT at oil sands operations, there is still a need for techniques and advances that can enable MFT drying for conversion into reclaimable landscapes.

### SUMMARY OF THE INVENTION

One aspect of the invention provides a method of enhancing solid-liquid separation, comprising: (1) adding a C1-C5 (e.g., a C1-C3, preferably C3) alcohol to a solid-liquid composition to achieve a final alcohol percentage of about 20-45% (w/w) or about 25-50% (v/v); (2) mixing the alcohol and the solid-liquid composition to form a mixture; (3) separating liquid from solid in the mixture.

In certain embodiments, the solid-liquid composition comprises at least about 30%, 40%, 50%, 60%, 70%, 80%, 90%, 95% water.

In certain embodiments, the solid-liquid composition comprises dissolved solid.

In certain embodiments, the solid-liquid composition is anaerobic digestate or a fraction thereof (e.g., a mechanically/screw press-separated digestate fraction), silt, or oil sands tailings (e.g., mature fine tailing or CT overflow).

In certain embodiments, the low molecular weight alcohol is dissolved or dispersed in a liquid (90% or 80% recycled isopropanol, 95% ethanol, etc.).

In certain embodiments, the C1-C3 alcohol is methanol, ethanol, 1-propanol, isopropanol, or a mixture thereof.

In certain embodiments, the C1-C3 alcohol is not cyclopropanol.

In certain embodiments, the C1-C3 alcohol is not 1-butanol or 2-butanol.

In certain embodiments, in step (1), the C1-C3 alcohol is isopropanol, and the final alcohol percentage is about 30-40% (v/v), about 35% (v/v), about 25-35% (w/w), or about 30% (w/w).

In certain embodiments, step (2) is carried out by vortexing, (vigorous) shaking, or stirring (including industrial mixing). Commercially, step (2) may be achieved using a pipe mixer, or a CSTR reactor. No cakes or films are expected to occur even when improper mixing occurs.

In certain embodiments, step (3) is carried out by centrifugation (e.g., about 3500-4000 rcf for 5 min).

In certain embodiments, the method further comprises: (4) recovering at least a portion of the alcohol after step (3).

In certain embodiments, the method further comprises: (5) recycling at least a portion of the alcohol recovered in step (4) for use in step (1).

In certain embodiments, the solid-liquid composition is mature fine tailing (MTF), and wherein bitumen, such as residual bitumen, is recovered. In this embodiment, an optimal concentration of isopropanol of around 25% (v/v) may be used. In certain embodiments, when bitumen recovery is desired (e.g., when it is economical), the alcohol (e.g., isopropanol) is first added to this lower optimal concentration to recovery bitumen, and then additional isopropanol is added to a higher optimal concentration to separate the solids.

Another aspect of the invention provides a method of extracting petroleum from bituminous sands, comprising: (1) using a water-requiring extraction method, extracting petroleum from bituminous sands, and producing petroleum and an aqueous sludge by-product; and, (2) using the method of claim 1, dewatering the aqueous sludge by-product to produce recycled water and a solid sediment.

In certain embodiments, the method further comprises: (3) re-using the recycled water from step (2) in step (1).

In certain embodiments, the method further comprises depositing the solid sediment in a landfill.

It should be understood that the embodiments of the invention are contemplated to be able to combine with any other embodiments of the invention, including embodiments described only under a specific aspect of the invention.

### BRIEF DESCRIPTION OF THE DRAWINGS

FIG. 1 shows an unexpected improvement in efficiency of solid liquid separation when the percentage of the final weight of isopropanol reaches approximately 30% (v/v). “Supernatant TS %” denotes the percent of total solids found in the supernatant after the solid liquid composition has undergone centrifuging at 3700 rcf for 5 minutes. “Solvent Volume Fraction” denotes the percentage of the final weight of the solvent (v/v), in this experiment isopropanol.

FIG. 2 demonstrates the effect of various solvents on the efficiency of solid liquid separation. There is a sharp increase in efficiency of solid liquid separation, for both centrate and separated liquids, when the percentage of the final weight of the solvent reaches approximately 25% (v/v). The polymer has a slight increase in efficiency when the final weight of the solvent reaches approximately 35% (v/v). “Supernatant TS %” denotes the percentage of total solids found in the supernatant after the solid liquid solution has undergone centrifuging at 3700 rcf for 5 minutes. “Solvent Volume Fractions” denotes the percentage of the final weight of the solvent used (v/v), in this experiment centrate, polymer 8110 (BASF) and separated liquids.

FIG. 3 shows the fairly constant result isopropanol produces in the amount of solids settled out of the solution. When the percentage of the final weight of isopropanol reaches approximately 55% (v/v) there is an increase in the efficiency. “Pellet TS %” denotes the percent of total solids found in the pellet after centrifuging at 3700 rcf for 5 minutes. “Solvent Volume Fraction” denotes the percentage of the final weight of the solvent (v/v), in this experiment isopropanol.

FIG. 4 shows an increase in efficiency in the solid liquid separation when the percentage of the solvent increases. The separated liquids have a sharp increase in efficiency when the percentage of the final weight of the solvent reaches approximately 35% (v/v). For centrate, there is an increase in efficiency when the percentage of the final weight of the solvent reaches approximately 15% (v/v). For the polymer, there is an increase in efficiency when the percentage of the solvent of the final weight reaches approximately 25% (v/v). “Pellet TS %” denotes the percentage of the total solids found in the pellet after centrifuging at 3700 rcf for 5 minutes. “Solvent Volume Fraction” denotes the percentage of the final weight of the solvent (v/v), in this experiment centrate, polymer 8110 and separated liquids.

FIG. 5 shows a step change increase in efficiency of yield when the percentage of the final weight of isopropanol reaches 35% (v/v). The “Separation Yield %” shows the dry weight yield from the digestate. The dry weight is achieved after centrifuging at 3700 rcf for 5 minutes and then putting in a forced air oven until dry. “Solvent Volume Fraction” denotes the percentage of the final weight of the solvent (v/v), in this experiment isopropanol.

FIG. 6 shows the yield of separated liquids, centrate and polymer. At 15% (v/v) solvent volume fraction the separated liquids and centrate increase sharply in yield. The polymer increases in efficiency at 25% (v/v) solvent volume fraction. These samples were centrifuged at 3700 rcf for 5 minutes then were put in a forced air oven to dry.

FIG. 7 shows an unexpected increase in efficiency of solid liquid separation when mature fine tailings (MFT), CT overflow, and lab extracted tailings are mixed with isopropanol. The mature fine tailings decrease drastically in supernatant TS immediately after adding isopropanol, and at 40% (v/v) solvent volume fraction, the supernatant TS has decreased to almost 0%. The CT overflow has an increase in efficiency at 20% solvent volume fraction, and has reached a supernatant TS level of almost 0% at a solvent volume fraction level of 60%. Lab extraction tailings start out with very low levels of supernatant TS, and by 40% solvent volume fraction, they have reached a supernatant TS level of almost 0%. The solvent was isopropanol, and the samples were centrifuged at 3700 rcf for 5 minutes.

FIG. 8 shows a decrease in pellet TS as the solvent volume fraction increases. The mature fine tailings have a linear decrease in pellet TS. CT overflow has a step change at 40% solvent volume fraction, the pellet TS then increases at 60% solvent volume fraction before continuing on a linear decrease. The lab extraction tailing follow a linear decrease until 60% solvent volume fraction where there is a step change in the pellet TS. The solvent was isopropanol, and the samples were centrifuged at 3700 rcf for 5 minutes.

FIG. 9 shows a decrease in the supernatant TS when the solvent volume fraction increases. At a solvent volume fraction of 50%, there is a step change in the supernatant TS. This step change follows the predicted transition of methanol. Methanol was the solvent used in this experiment, and the samples were centrifuged at 3700 rcf for 5 minutes.

FIG. 10 shows two step changes in the pellet TS of methanol. The first step change occurs at 15% solvent volume fraction, with the second step change taking place at 45% solvent volume fraction. After the second step change the pellet TS increases sharply. The solvent used in this experiment was methanol, and the samples were centrifuged at 3700 rcf for 5 minutes.

FIG. 11 shows the separation yield for digestate using methanol. This graph produces an almost continual rise in yield with the exception of a step change at 50% solvent volume fraction, which results in a decrease in yield. The step change at the 50% solvent volume fraction occurs at the predicted transition for methanol. The samples were centrifuged at 3700 rcf for 5 minutes.

FIG. 12 shows an unexpected increase in efficiency that occurs at the 35% solvent volume fraction. Before the step change, the supernatant TS decreases linearly, the step change evens out around 45% solvent volume fraction, after which the supernatant TS decreases linearly once more. The solvent used in this experiment was ethanol, and the samples were centrifuged at 3700 rcf.

FIG. 13 shows the pellet TS with the ethanol as the solvent. The pellet TS decreases sharply until a step change at solvent volume fraction 45%, above the 50% solvent volume fraction mark, there is a sharp increase in the pellet TS. The solvent used in this experiment was ethanol, and the samples were centrifuged at 3700 rcf for 5 minutes.

FIG. 14 shows an increase in separation yield. At 30% solvent volume fraction, there is a step change, which settles at approximately 45% solvent volume fraction. There is a linear increase in separation yield after the step change. The solvent used for this experiment was ethanol, and the samples were centrifuged at 3700 rcf for 5 minutes.

FIG. 15 shows an unexpected increase in efficiency in solid liquid separation. There is a linear decrease in supernatant TS before 30% solvent volume fraction, at which point there is a step change that ends at 40% solvent volume fraction. After the step change there is again a linear decrease in the supernatant TS. The solvent used in this experiment was 1-propanol, and the samples were centrifuged at 3700 rcf for 5 minutes.

FIG. 16 shows the pellet TS for the separation of digestate using 1-propanol. The pellet TS appears to have no real correlation to the solvent volume fraction, nor is there any pattern to describe. There does appear to be a somewhat linear increase in pellet TS for 0% to 15% and 45%-55% solvent volume fraction. The samples were centrifuged at 3700 rcf for 5 minutes.

FIG. 17 shows the increase in separation yield of digestate using 1-propanol. The yield has a slight increase until a step change at 25% solvent volume fraction. The step change ends at 40% solvent volume fraction, after which there is a linear increase in the separation yield. The samples were centrifuged at 3700 rcf for 5 minutes.

FIG. 18 shows the supernatant TS of solid liquid separation using 1-butanol as the solvent. There is a linear decrease in supernatant TS until 10% solvent volume fraction, at which point there is a step change, and at 15% solvent volume fraction there is another linear decrease in supernatant TS. The solvent used in this experiment was 1-butanol, and the samples were centrifuged at 3700 rcf for 5 minutes.

FIG. 19 shows the pellet TS of solid liquid separation using 1-butanol as the solvent. There is a linear increase in pellet TS until a step change at 10% solvent volume fraction. At 15% solvent volume fraction, there is a linear decrease in pellet TS. The solvent used in this experiment was 1-butanol, and the samples were centrifuged at 3700 rcf for 5 minutes.

FIG. 20 shows the separation yield of digestate separation. The values are scattered, however, after a 50% solvent volume fraction, there is a continued increase in separation yield. The solvent used on this experiment was 1-butanol, and the samples were centrifuged at 3700 rcf for 5 minutes.

FIG. 21 shows the supernatant TS of solid liquid separation using 2-butanol as the solvent. There is a linear decrease in supernatant TS until the step change at 45% solvent volume fraction. At 55% solvent volume fraction, there is another linear decrease in the supernatant TS. The solvent was 2-butanol, and the samples were centrifuged at 3700 rcf for 5 minutes.

FIG. 22 shows the pellet TS of solid liquid separation. There is a linear increase in pellet TS until 10% solvent volume fraction, after this there is a step change followed by a decrease in pellet TS until 45% solvent volume fraction. There is then another step change at 50% solvent volume fraction, and at 55% there is another continuous decrease in pellet TS. The solvent used for this experiment was 2-butanol, and the samples were centrifuged at 3700 rcf for 5 minutes.

FIG. 23 shows the separation yield of solid liquid separation. The yield is fairly constant until a step change at 45% solvent volume fraction, at 50% solvent volume fraction, there is an increase in the separation yield. The solvent used for this experiment was 2-butanol, and the samples were centrifuged at 3700 rcf for 5 minutes.

FIG. 24 shows an unexpected improvement in efficiency of solid liquid separation when the percentage of the final volume of n-pentanol reaches approximately 35% (v/v). “Supernatant TS %” denotes the percent of total solids found in the supernatant after the solid liquid composition has undergone centrifuging at 3700 rcf for 5 minutes. “Solvent Volume Fraction” denotes the percentage of the final weight of the solvent (v/v), in this experiment n-pentanol.

FIG. 25 shows the approximately constant pellet TS % of n-pentanol/digestate mixtures after centrifugation.

FIG. 26 shows an increase in separation yield with addition of n-pentanol to digestate after centrifugation.

FIG. 27 shows an unexpected improvement in efficiency of solid liquid separation when the percentage of the final volume of 60% isopropanol/40% ethyl acetate reaches approximately 30% (v/v). “Supernatant TS %” denotes the percent of total solids found in the supernatant after the solid liquid composition has undergone centrifuging at 3700 rcf for 5 minutes. “Solvent Volume Fraction” denotes the percentage of the final weight of the solvent (v/v), in this experiment 60% isopropanol/40% ethyl acetate.

FIG. 28 shows the result of the pellet TS % of a 60% isopropanol/40% ethyl acetate mixture.

FIG. 29 shows an unexpected increase in separation yield efficiency that occurs at the 35% solvent volume fraction of a solution that consists of 60% isopropanol/40% ethyl acetate.

FIG. 30 shows the constant decrease in supernatant TS % for water/digestate mixtures. It demonstrates the dilution effect of solvents.

FIG. 31 shows an unexpected decrease in pellet TS % for water/digestate mixtures at approximately 0.65 water volume fraction. This demonstrates the dilution effect of solvents.

FIG. 32 shows an almost constant, slightly decreasing separation yield percentage for water/digestate mixtures. This demonstrates the dilution effect of solvents.

FIG. 33 demonstrates that recycled, impure isopropanol separates digestate in a similar fashion as pure isopropanol, at the same isopropanol volume concentration. There is a step change decrease in the supernatant TS % at 0.35 isopropanol volume fraction-equivalent concentration.

FIG. 34 shows the same data as above, but the x-axis is the solvent volume fraction added to the digestate of 80% isopropanol/20% water. Using 80% isopropanol shifts the step change to a higher solvent volume fraction in a manner proportional to the concentration of the isopropanol water solution. That is, a 80% isopropanol/20% water mixture would extract optimally at 0.35/0.8=0.438 or 43.8% solvent volume fraction. A 60% isopropanol/40% water mixture would extract optimally at 0.35/0.6=0.583 or 58.3% solvent volume fraction.

FIG. 35 shows the pellet TS % from extraction with 80% isopropanol.

FIG. 36 shows an increase in separation yield from 70% to 84% at 0.45 isopropanol concentration (which correlates to a 0.35 equivalent pure isopropanol concentration).

### DETAILED DESCRIPTION OF THE INVENTION

### 1. Overview

The invention described herein provides a method to enhance solid-liquid separation using a low molecular weight alcohol, such as a C1-C5 alcohol, preferably a C1-C3 alcohol, more preferably a C3 alcohol (such as isopropanol). It was unexpectedly discovered that such low molecular weight alcohol, when added to a solid-liquid composition to achieve a final alcohol percentage of about 25-45% (v/v), enhances the separation of solid from liquid such that the residual total solid content in the separated liquid is significantly reduced, and/or the total solid content in the separated solid is increased, such as to a level suitable for disposal as landfill solid.

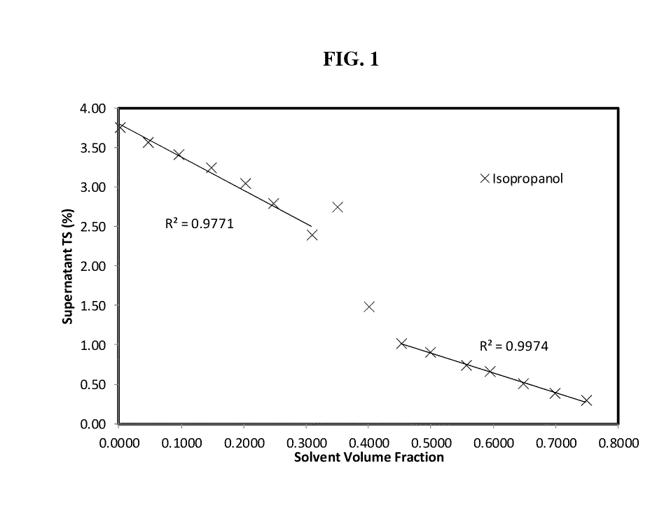

Merely to illustrate, in FIG. 1, as the final alcohol percentage in the alcohol-composition mixture (“Solvent Volume Fraction”) increases (X-axis), the Supernatant Total Solids (“Supernatant TS %”) in the separated liquid constantly/proportionally decreases between solvent volume fractions of 0% to about 35% (v/v), such that a liner relationship between the solvent volume fraction and the supernatant TS % is observed. However, once the solvent volume fraction exceeds about 35%, a significant decrease in supernatant TS % unexpectedly occurred, such that the linear relationship between solvent volume fraction and supernatant TS % is largely maintained (about the same slop), but with a significantly down-shifted Y-axis interception that represents a significantly lower supernatant TS % than expected. This observation suggests that using about 35% (v/v) low molecular weight alcohol offers the optimal balance between the enhanced solid-liquid separation efficiency and using the least amount of alcohol.

Thus in one aspect, the invention provides a method of enhancing solid-liquid separation, comprising: (1) adding a C1-C5 (e.g., a C1-C3, preferably C3) alcohol to a solid-liquid composition to achieve a final alcohol percentage of about 20-45% (w/w) or about 25-50% (v/v); (2) mixing the alcohol and the solid-liquid composition to form a mixture; and (3) separating liquid from solid in the mixture.

As used herein, “solid-liquid composition” includes a composition that contains solids dissolved in liquids, and/or solids distributed in liquids as suspension, dispersion, or colloid. In certain embodiments, the solid-liquid composition that can be treated by the methods of the invention has (non-dissolved) solids that may be particles having an average particle size of between about 1-50 microns (e.g., 2-44 microns), or may be particles having an average particle size of between 44 microns and millimeters. In certain embodiments, such as in anaerobic digestate effluents, the solid-liquid composition has a wide range of particle sizes, with most particles having sizes between 1-200 microns, optionally with a binomial distribution with large particulates (such as straw).

In certain embodiments, the solid-liquid composition comprises at least about 30%, 40%, 50%, 60%, 70%, 80%, 90%, 95% water (w/w or v/v).

In certain embodiments, the solid-liquid composition comprises dissolved solid.

In certain embodiments, the solid-liquid composition is anaerobic digestate or a fraction thereof (e.g., a mechanically/screw press-separated digestate fraction), silt, or oil sands tailings (e.g., mature fine tailing or CT overflow).

For example, solid-liquid separation of effluent from an anaerobic digestion tank can be initially carried out using mechanical means, such as a screw press. The separated liquid obtained from the screw press may be further treated by, for example, centrifugation, and/or one or more filtrations using, for example, membranes of various pore sizes (ultrafiltration or UF, nanofiltration or NF, etc.). Reverse osmosis (RO) may also be employed to further purify the liquid separate, such that the total solids in the liquid separate (e.g., supernatant) is decreased. The methods of the invention may be applied at any stage of the above-referenced solid-liquid separation process, including treatment of: the initial AD effluent before any mechanical separation, a liquid separate just after mechanical separation, a liquid separate after an initial low speed centrifugation (e.g., about 500 g), or a liquid separate before or after any of the membrane-based filtration (UF, NF) or RO.

In another embodiment, oil sands tailing sludge that otherwise would have been deposited in tailing ponds can be processed using the methods of the invention, preferably using isopropanol as the low molecular weight alcohol.

As used herein, “C1-C5 alcohol” includes an alcohol having 1-5 carbon atoms. “Alcohol” includes an organic compound in which a hydroxyl functional group (—OH) is bound to a carbon atom. Exemplary C1-C5 alcohols include methanol, ethanol, n-propanol, isopropanol (iPr), n-butanol, isobutanol, t-butanol, 1-hydroxy-2-propanone, 2-methyl-2-butanol, n-pentanol, cyclopentanol, or mixtures thereof. Preferably, the C1-C5 alcohol of the invention is a monohydric alcohol having only one hydroxyl group. Preferably, the C1-C5 alcohol of the invention does not include an unsaturated carbon.

In certain embodiments, the C1-C5 alcohol is the C1-C3 alcohol.

In certain embodiments, the C1-C5 alcohol is isopropanol, preferably at 35% (v/v).

In certain embodiments, the C1-C5 alcohol is not cyclopentanol.

In certain embodiments, the C1-C5 alcohol is not 1-butanol or 2-butanol.

In certain embodiments, the C1-C5 alcohol is solution that consists of 60% isopropanol/40% ethyl acetate at 35% solvent volume fraction.

In certain embodiment, the final alcohol content of the mixture is adjusted depending on the alcohol used, and the identity of the solid-liquid composition. The table below shows predicted final volume fractions of various solvents of the invention in mixtures of solid-liquid composition (e.g., wastewater, oil sands tailings, etc.) that corresponds to the improvement efficiency in solid liquid separation.

| | | | | Volume | Volume | | | | |
|---|---|---|---|---|---|---|---|---|---|
| | | | | Fraction | Fraction | | | | |
| | | | | Solvent | Water | Weighted Parameter | | | Ra |
| | δ_{D} | δ_{P} | δ_{H} | A | B = 1-A | δ_{D} | δ_{P} | δ_{H} | (wrt 35% iPr)) |
| MeOH | 14.7 | 12.3 | 22.3 | | | | | | |
| Water | 15.5 | 16 | 42.3 | | | | | | |
| iPr | 15.8 | 6.1 | 16.4 | 0.35 | 0.65 | 15.605 | 12.535 | 33.235 | |
| Ethanol | 15.8 | 8.8 | 19.4 | 0.40 | 0.60 | 15.6211 | 13.0948 | 33.05984 | 0.587438484 |
| Acetone | 15.5 | 10.4 | 6.95 | 0.27 | 0.73 | 15.5 | 14.51429 | 32.92145 | 2.014943915 |
| n-BuOH | 16 | 5.7 | 15.8 | 0.34 | 0.66 | 15.6706 | 12.48596 | 33.25901 | 0.142082121 |
| i-BuOH | 15.8 | 5.7 | 14.5 | 0.33 | 0.67 | 15.5982 | 12.62845 | 33.20008 | 0.100680978 |
| t-BuOH | 15.2 | 2.1 | 14.7 | 0.31 | 0.69 | 15.4063 | 11.66075 | 33.68393 | 1.060050841 |
| n-Pentanol | 15.9 | 4.5 | 13.9 | 0.32 | 0.68 | 15.6267 | 12.35871 | 33.3076 | 0.195509532 |
| MeOH | 14.7 | 12.3 | 22.3 | 0.47 | 0.53 | 15.124 | 14.261 | 32.9 | 2.004181878 |
| 80% iPr | 15.7 | 8.08 | 21.6 | 0.44 | 0.56 | 15.605 | 12.535 | 33.235 | 6.76028E−07 |

The above calculation is based on the standard method of Charles M. Hansen (Solubility Parameters—An Introduction. In Hansen Solubility Parameters, CRC Press: 2007; pp 1-26, incorporated herein by reference). The solubility parameters above serve as a guideline for such molecules and other structurally or chemically very similar molecules.

In certain embodiments, the low molecular weight alcohol is dissolved or dispersed in a liquid. For example, the alcohol may be recovered or recycled from the process of the invention, and contains about 90% or 80% recycled alcohol (e.g., isopropanol). Alternatively, the alcohol is commercially available low grade industrial grade alcohol, such as 95% ethanol, etc.

In certain embodiments, alcohol is added to the solid-liquid composition to achieve a final alcohol percentage of about 20-45% (w/w), about 25-40% (w/w), about 25-35% (w/w), about 30-35% (w/w), or about 30% (w/w).

In certain embodiments, alcohol is added to the solid-liquid composition to achieve a final alcohol percentage of about 25-50% (v/v), about 30-40% (v/v), about 30-45% (v/v), about 35-40% (v/v), or about 35% (v/v).

In certain embodiments, the residual TS % in the separated liquid is reduced by at least about 30%, 40%, 50%, 60%, 70%, 80% or more compared to the expected value if no enhanced separation occurs.

In certain embodiments, the alcohol and the solid-liquid composition are mixed to form a mixture by any art recognized means. For example, the mixing may be done by vortexing, stirring (by a mechanical device such as a mixer), and/or vigorous shaking. Such mixing can be done in a variety of equipment or devices, such as in a pipe static mixer or in a CSTR reactor.

In certain embodiments, the mixture of alcohol and the solid-liquid separation can be separated into a supernatant and a pellet by centrifugation. Regardless of the instrument used for centrifugation, the g force and centrifugation time can be adjusted based on factors such as the type of mixture, the volume of the mixture, the type of the rotor etc. In an illustrative embodiment, the centrifugation may be carried out at about 3000-5000 rcf, about 3500-4500 rcf, or about 3500-4000 rcf for 3, 5, 7, 10 or more minutes.

In certain embodiments, the separated pellet has a TS % (weight) of at least about 40%, 45%, 50%, 55%, 60%, 65%, 70%, 75%, 80%, 85%, 90%, or 95%.

In certain embodiments, the separated solids are further dried, and or the solvent therein further recovered, to further increase the TS %.

In certain embodiments, the separated pellet has sufficient TS % for disposal at a landfill (e.g., >50%, >55%, >60%, >65%, >70%, >75% etc.), such as one that can be or is destined to be eventually covered by top soil and reclaimed.

In certain embodiments, the low molecular weight alcohol in the separated liquid or supernatant (e.g., isopropanol) may be recovered or partially recovered for reusing in the methods of the invention. The recovery rate of the alcohol may be at least about 60%, 70%, 80%, 90%, 95%, 99%, 99.5%, 99.9%, 99.95% or more. At least a portion of such recovered alcohol may be reused in the methods of the invention. The recovered alcohol may contain certain percentage (e.g., <30%, <25%, <20%, <15%, <10%, <5%, <3%, <1%) of impurities, water, or both.

In certain embodiments, the solid-liquid composition is mature fine tailing (MTF), and at least a portion of the bitumen in the MFT is recovered. For example, at least about 10%, 15%, 20%, 25%, 30%, 35%, 40%, 45%, 50%, 55%, 60%, 65%, 70%, 75%, 80%, 85%, 90%, 95% of the bitumen in the MTF may be recovered by the methods of the invention

In another aspect, the invention provides a method of extracting petroleum from bituminous sands, comprising: (1) using a water-requiring extraction method, extracting petroleum from bituminous sands, and producing petroleum and an aqueous sludge by-product; and, (2) using any of the solid-liquid separation method of the invention described herein, dewatering the aqueous sludge by-product to produce recycled water and a solid sediment.

As used herein, “water-requiring extraction method” includes methods to extract petroleum from bituminous sands that utilizes a large or significant volume of water, and produces a waste water stream that traditionally needs to be deposited in tailing point, such as mature fine tailing (MFT). Such methods include surface mining, Cold Flow, Cyclic Steam Stimulation (CSS), Steam Assisted Gravity Drainage (SAGD), Vapor Extraction Process (VAPEX), Combustion Overhead Gravity Drainage (COGD), etc.

After petroleum is extracted from the bituminous sands, an aqueous sludge by-product is generated which must be properly disposed of. Instead of pumping the final waste stream, the mature fine tailing, into tailing ponds for long-term deposit/settling, the solid-liquid separation methods described above may be used to separate the MFT or MFT-like sludge into a supernatant that is low on TS %, and a pellet that is high on TS % and is solid enough for direct disposal in a suitable landfill. Thus the solid-liquid separation process of the invention becomes an integral part of the petroleum extraction process that produces both petroleum and a waste by-product, thus an integral part of the waste management process of petroleum extraction from oil sands.

### 2. Oil Sands and Extraction Methods

### Oil Sands and Deposits

As used herein, “oil sands,” “tar sands,” or “bituminous sands” are used interchangeably to refer to a type of unconventional petroleum deposit that comprises loose sand or partially consolidated sandstone containing naturally occurring mixtures of sand, clay, and water, saturated with a dense and extremely viscous form of petroleum technically referred to as bitumen. The crude bitumen contained in the Canadian oil sands is described by Canadian authorities as “petroleum that exists in the semi-solid or solid phase in natural deposits. Bitumen is a thick, sticky form of crude oil, so heavy and viscous (thick) that it will not flow unless heated or diluted with lighter hydrocarbons. At room temperature, it is much like cold molasses.” The World Energy Council (WEC) defines natural bitumen as “oil having a viscosity greater than 10,000 centipoises under reservoir conditions and an API gravity of less than 10° API.” Oil sands meeting any one of the definitions above are within the scope of the invention.

According to the WEC, natural bitumen is reported in 598 deposits in 23 countries, with extremely large quantities found in Canada, Kazakhstan, and Russia. Total natural bitumen reserves are estimated to be around 249.67 billion barrels (39.7×10⁹ m³) globally, of which 176.8 billion barrels (28×10⁹ m³), or about 71%, are in Canada.

Most of the oil sands of Canada are located in three major deposits in northern Alberta: the Athabasca-Wabiskaw oil sands of north northeastern Alberta, the Cold Lake deposits of east northeastern Alberta, and the Peace River deposits of northwestern Alberta. The portion of the deposits in these three areas, which is estimated by the government of Alberta to be recoverable at current prices, using current technology, amounts to about 97% of Canadian oil reserves and 75% of total North American petroleum reserves.

The largest bitumen deposit, containing about 80% of the Alberta total, and the only one suitable for surface mining, is the Athabasca oil sands along the Athabasca River. The smaller Cold Lake deposits are important because some of the oil is fluid enough to be extracted by conventional methods. All three Alberta areas are suitable for production using in-situ methods, such as cyclic steam stimulation (CSS) and steam assisted gravity drainage (SAGD).

Oil Extraction from Oil Sands

Conventional crude oil is normally extracted from the ground by drilling oil wells into a petroleum reservoir, allowing oil to flow into them under natural reservoir pressures. Because bitumen flows very slowly, if at all, toward producing wells under normal reservoir conditions, the sands must be extracted by strip mining or the oil made to flow into wells by in-situ techniques, which reduce the viscosity by injecting steam, solvents, and/or hot air into the sands. These processes generally use more water and require larger amounts of energy than conventional oil extraction. It is estimated that oil sands extraction generally generates two to four times the amount of greenhouse gases per barrel of final product as the production of conventional oil.

About 90% of the Alberta oil sands are too far below the surface to use open-pit mining. Several in-situ techniques have been developed, as described in more details below.

### Surface Mining

Bitumen has been extracted on a commercial scale from the Athabasca Oil Sands since the 1960's by surface mining, which is most efficient for oil sands fields with very large amounts of bitumen covered by little overburden, such as those in Athabasca.

In such operations, the surface overburden (usually consists of water-laden muskeg or peat bog over top of clay and barren sand) is first moved, and the covered oil sands layer (typically 40 to 60 meters deep, deposited on top of rock layers) is exposed and physically excavated (e.g., using draglines, bucket-wheel excavators, power shovels (100 or more tons)), and transported to downstream process plants via conveyor belts or dump trucks (400 tons).

After excavation, hot water and caustic soda (NaOH) is added to the sand, and the resulting slurry is piped to the extraction plant where it is agitated and the oil skimmed from the top. Provided that the water chemistry is appropriate to allow bitumen to separate from sand and clay, the combination of hot water and agitation releases bitumen from the oil sand, and allows small air bubbles to attach to the bitumen droplets. The bitumen froth floats to the top of separation vessels, and is further treated to remove residual water and fine solids.

In general, about two tons of oil sands are required to produce one barrel (roughly ⅛ of a ton) of oil. Originally, roughly 75% of the bitumen was recovered from the sand. Recent enhancements to this method include Tailings Oil Recovery (TOR) units which recover oil from the tailings, Diluent Recovery Units to recover naptha from the froth, Inclined Plate Settlers (IPS) and disc centrifuges. These allow the extraction plants to recover well over 90% of the bitumen in the sand.

After oil extraction, the spent sand and other materials are then returned to the mine, which is eventually reclaimed.

In an alternative method, Alberta Taciuk Process technology extracts bitumen from oil sands through a dry-retorting. During this process, oil sand is moved through a rotating drum, cracking the bitumen with heat and producing lighter hydrocarbons.

### Cold Flow

In areas where the oil is fluid enough, a technique also known as cold heavy oil production with sand (CHOPS) may be used to simply pump oil out of the sands, often using progressive cavity pumps. This technique has been used in the Wabasca, Alberta Oil Sands, the southern part of the Cold Lake Oil Sands, and the Peace River Oil Sands.

The advantage of this method is better production rates and recovery (around 10%), but the disadvantage is that disposing of the produced sand, such as by spreading it on rural roads, can become a problem as rural governments have become concerned about the large volume and composition of oil spread on roads. In recent years, disposing of oily sand in underground salt caverns has become more common.

### Cyclic Steam Stimulation (CSS)

The use of steam injection to recover heavy oil has been in use in the oil fields since the 1950s. In this method, the well is put through cycles of steam injection, soak, and oil production. First, steam is injected into a well at a temperature of about 300-340° C. for a period of weeks to months; then, the well is allowed to sit for days to weeks to allow heat to soak into the formation; finally, the hot oil is pumped out of the well for a period of weeks or months. Once the production rate falls off, the well is put through another cycle of injection, soak, and production. This process can be repeated until all oil is extracted, but is typically repeated until the cost of injecting steam becomes higher than the money made from producing oil.

The CSS method has the advantage that recovery factors are around 20 to 25% and the disadvantage that the cost to inject steam is high.

### Steam Assisted Gravity Drainage (SAGD)

Steam assisted gravity drainage was developed in the 1980s, in which two horizontal wells are drilled in the oil sands, one at the bottom of the formation and another about 5 meters above it. These wells are typically drilled in groups off central pads and can extend for miles in all directions. In each well pair, steam is injected into the upper well such that the heat melts the bitumen, and allows it to flow into the lower well, where it is pumped to the surface.

SAGD has proved to be a major breakthrough in production technology since it is cheaper than CSS, allows very high oil production rates, and recovers up to 60% of the oil in place. Because of its very favorable economics and applicability to a vast area of oil sands, this method alone quadrupled North American oil reserves and allowed Canada to move to second place in world oil reserves after Saudi Arabia.

Alberta's OSUM Corp has combined proven underground mining technology with SAGD to enable higher recovery rates by running wells underground from within the oil sands deposit, thus also reducing energy requirements compared to traditional SAGD.

### Vapor Extraction Process (VAPEX)

VAPEX is similar to SAGD but instead of steam, hydrocarbon solvents are injected into the upper well to dilute the bitumen and allow it to flow into the lower well. It has the advantage of much better energy efficiency over steam injection, and it does some partial upgrading of bitumen to oil right in the formation.

CSS, SAGD and VAPEX are not mutually exclusive. It is becoming common for wells to be put through one CSS injection-soak-production cycle to condition the formation prior to going to SAGD production, and companies are experimenting with combining VAPEX with SAGD to improve recovery rates and lower energy costs.

### Toe to Heel Air Injection (THAI)

This is a method that combines a vertical air injection well with a horizontal production well. The process ignites oil in the reservoir and creates a vertical wall of fire moving from the “toe” of the horizontal well toward the “heel,” which burns the heavier oil components and upgrades some of the heavy bitumen into lighter oil right in the formation.

The THAI method has the potential to be more controllable and practical, and have the advantage of not requiring energy to create steam. Advocates of this method of extraction state that it uses less freshwater, produces 50% less greenhouse gases, and has a smaller footprint than other production techniques.

### Combustion Overhead Gravity Drainage (COGD)

This method employs a number of vertical air injection wells above a horizontal production well located at the base of the bitumen pay zone. An initial Steam Cycle similar to CSS is used to prepare the bitumen for ignition and mobility. Following that cycle, air is injected into the vertical wells, igniting the upper bitumen and mobilizing (through heating) the lower bitumen to flow into the production well. It is expected that COGD will result in water savings of 80% compared to SAGD.

### Transportation and Refining

Once extracted, the oil sands are transported to processing plants for refining.

The heavy crude oil or crude bitumen extracted from oil sands is a viscous, solid or semisolid form that does not easily flow at normal oil pipeline temperatures, making it difficult to transport to market and expensive to process into gasoline, diesel fuel, and other products. It must be either mixed with lighter petroleum (either liquid or gas) or chemically split before it can be transported by pipeline for upgrading into synthetic crude oil.

Heavy crude feedstock needs pre-processing before it is fit for conventional refineries. This pre-processing is called “upgrading,” the key components of which are as follows:

1. removal of water, sand, physical waste, and lighter products;

2. catalytic purification by hydrodemetallization (HDM), hydrodesulfurization (HDS) and hydrodenitrogenation (HDN);

3. hydrogenation through carbon rejection or catalytic hydrocracking (HCR)

All these processes take large amounts of energy and water, while emitting more carbon dioxide than conventional oil. Catalytic purification and hydrocracking are together known as hydroprocessing.

### EXAMPLES

With the invention having been generally described above, the examples below are provided to demonstrate illustrative but non-limiting embodiments of the invention.

### Example 1

### Enhanced Solid-Liquid Separation in Anaerobic Digestate Using Isopropanol

This experiment demonstrates the step-change at 35% (v/v) isopropanol volume fraction resulted in a substantial decrease in supernatant TS, qualitative turbidity, and an increase in separation efficiency to 93%.

The digestate was obtained from a well-mixed, refrigerated sample bucket (1 of 4).

Centrate was prepared by adding 200 grams of digestate to each of three 250 mL centrifuge tubes for centrifugation for 5 minutes at 3700 rcf (4965 rpm) in a Beckman Coulter J-26XI Avanti Centrifuge. The Centrate is the recovered supernatant following the above centrifuge step.

Polymer Separated Digestate was prepared by adding 600 mL of digestate to 27.5 mL of 0.2% 8110 polymer (BSAF), pouring between beakers five times, transferring 200 grams to each of three 250 mL centrifuge tubes, centrifuging for 5 minutes at 3700 rcf (4965 rpm) in a Beckman Coulter J-26XI Avanti Centrifuge. The Polymer Separated Digestate is the supernatant following the above centrifuge step. Separated liquids were obtained by passing anaerobic digestate through a 500 micron screw press. Each sample was 40 mL and was prepared by adding isopropanol to digestate in centrifuge tube from 0 to 75% volume isopropanol. The weight of digestate and isopropanol was measured using an analytical balance accurate to 0.1 mg. After vigorous mixing, the samples were centrifuged at 3700 rcf for five minutes in a Thermo Scientific Heraeus Megafuge 40 Centrifuge at 20° C. The supernatant was decanted into a tarred crucible. After weighing the pellet mass, a sample was transferred to a tarred crucible. Crucibles with samples were placed in a forced-air convection oven at 70° C. for 48 hours and the resulting dry weight was measured.

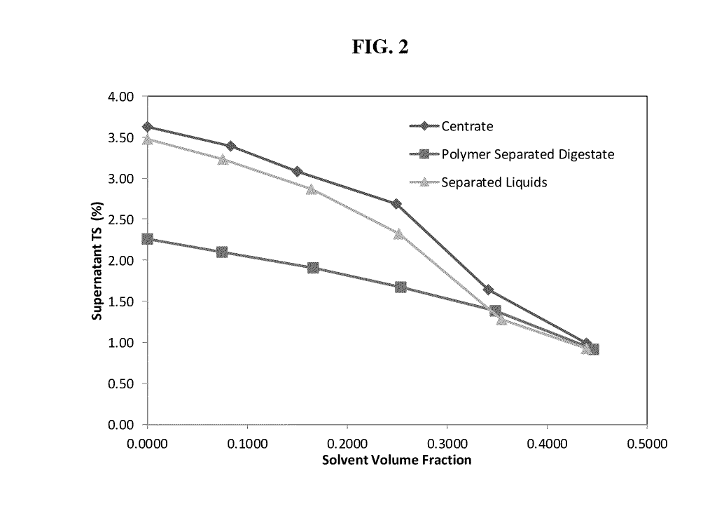

The supernatant total solid (TS) % for digestate/isopropanol mixtures is shown in FIG. 1. The supernatant TS % for Centrate, Polymer Separated Digestate, and Separated Liquids mixtures with isopropanol is shown in FIG. 2. The supernatant total solid (TS) % was measured from the supernatant of the centrifuged isopropanol/digestate samples for various isopropanol solvent volume fractions (“iPr vol frac”).

It is apparent that, as the iPr vol frac increases, there is a linear decrease in supernatant TS % between 0 and approximately 0.25 iPr vol frac for digestate, centrate, and separated liquids. A step change is observed between about 0.3 and 0.4 iPr vol frac, with a sharp decrease in supernatant TS % for digestate, centrate, and separated liquids. After 0.4 iPr vol frac, a separate linear decrease in supernatant TS % is observed for digestate, centrate, and separated liquids. Although not measured quantitatively, the turbidity of the supernatant changes at 0.35 iPr vol frac from a murky brown to a clear, yellow liquid for digestate, centrate, and separated liquids.

On the other hand, there is only a linear decrease in supernatant TS % for polymer separated liquids.

The linear decreases in supernatant TS % between 0 to 0.25 and 0.4 to 0.7 iPr vol frac are likely due to dilution. Meanwhile, the significant drop in supernatant TS % between 0.25 and 0.4 iPr vol frac is probably from the precipitation of suspended solids for digestate, centrate, and separated liquids. There is apparently no enhanced separation for polymer separated digestate.

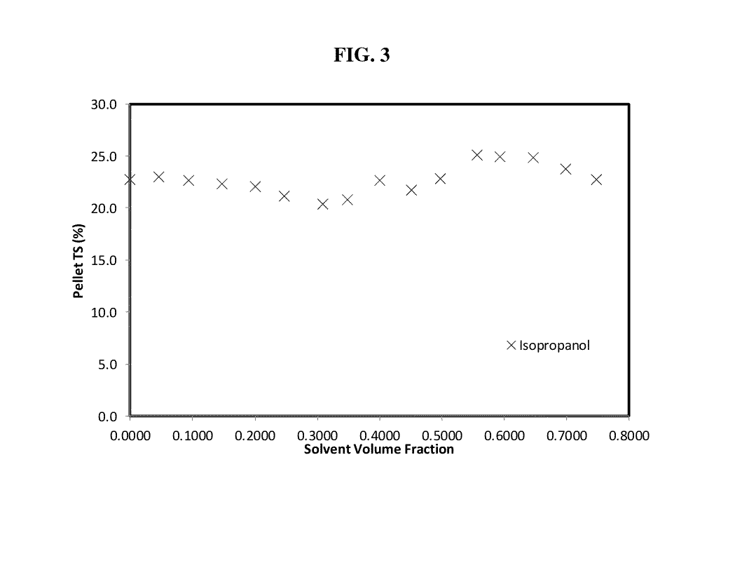

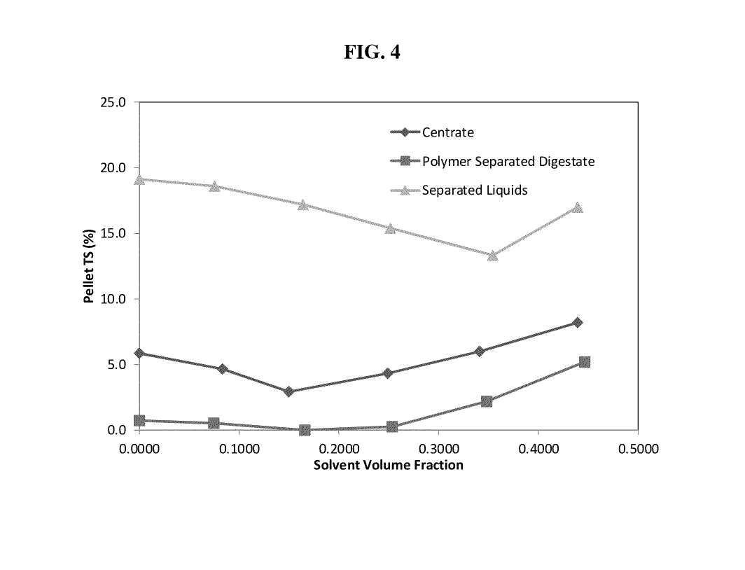

The pellet TS % was relatively constant for digestate/isopropanol mixtures, with a final value between 20 and 25 TS % (shown in FIG. 3). The pellet TS % was relatively constant for Centrate/Polymer Separated Digestate/Separated Liquids mixtures with isopropanol (shown in FIG. 4). At high (greater than 0.7) iPr vol frac, the pellet TS % content increases, probably due to more solids and salts being pushed out of solution into the pellet.

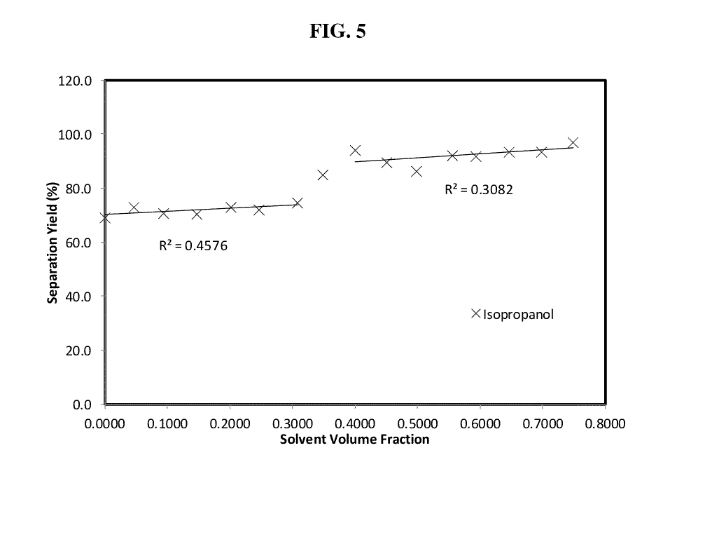

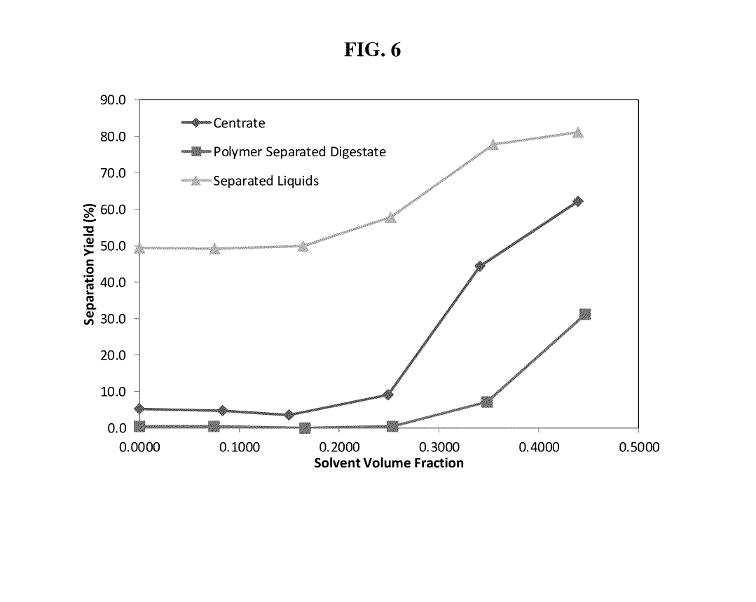

The separation yield percentage (“Separation Yield %”) of solids captured in the pellet (shown in FIG. 5 for digestate/isopropanol, and shown in FIG. 6 for Centrate/Polymer Separated Digestate/Separated Liquids mixtures with isopropanol) was calculated as the ratio of dry-basis solids in the pellet to dry-basis solids in the digestate component of the digestate/isopropanol mixture after centrifugation at 3700 rcf for 5 minutes. With no isopropanol added, approximately 70% of the solids are captured. At approximately 0.3 iPr vol frac, the separation yield increases to about 74-93%.

### Example 2

### Enhanced Solid-Liquid Separation in Mature Fine Tailing and CT Overflow Using Isopropanol

This experiment demonstrates the step-change at 0.35 isopropanol volume fraction resulted in a substantial decrease in supernatant TS, and in separation efficiency.

Samples of Lab extracted tailings, CT overflow, and Mature Fine Tailings (MFT) were mixed with isopropanol from 0 to 80% volume isopropanol. Lab extracted tailings were created from oil sands and process water, and contained about 0.831 (w/w) water, 0.016 (w/w) bitumen, 0.154 (w/w) solids, and about 51% fines in the solids. CT Overflow was obtained from hydrocyclone overflow tailings, after the completion of the CT process. Each sample was 40 mL, and was prepared by adding isopropanol to the sample. The weight of samples and isopropanol was measured using an analytical balance accurate to 0.1 mg. After vigorous mixing, the samples were centrifuged at 3700 rcf for five minutes in a Thermo Scientific Heraeus Megafuge 40 Centrifuge at 20° C. The supernatant was decanted into a tarred crucible. After weighing the pellet mass, a sample was transferred to a tarred crucible. Crucibles with samples were placed in a forced-air convection oven at 70° C. for 48 hours and the resulting dry weight was measured.

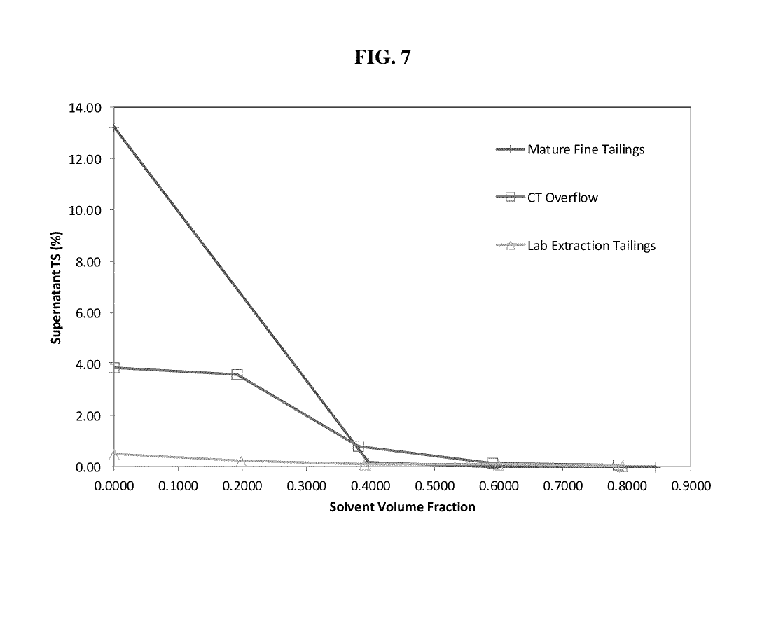

The supernatant TS % is given in FIG. 7 for lab extracted tailings, CT overflow, and mature fine tailings mixtures with isopropanol. The supernatant TS % was measured from the supernatant of the centrifuged isopropanol/digestate samples for various isopropanol solvent volume fractions (iPr vol frac). A step change was observed between 0 and 0.4 iPr vol frac with a sharp decrease in supernatant TS %. After 0.4 iPr vol frac, a separate linear decrease in supernatant TS % was observed.

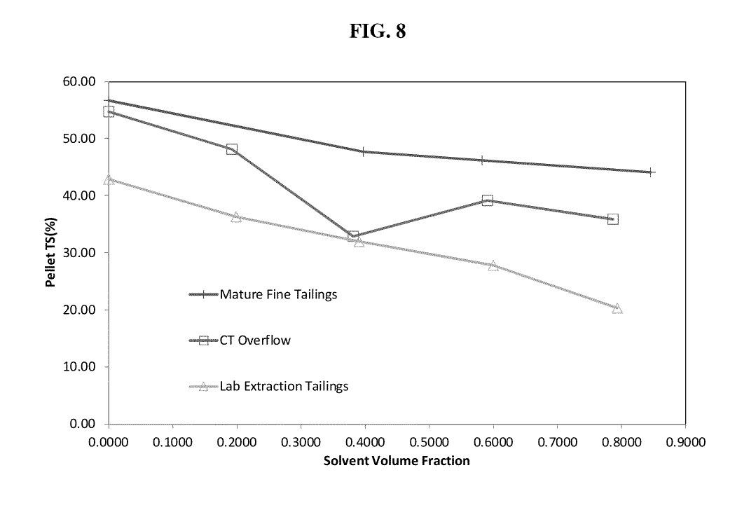

The pellet TS % was between a value of about 25 and 55% for either lab extracted tailings, CT overflow, and/or mature fine tailings mixtures with isopropanol shown in FIG. 8. The pellet TS % can be locally maximized around 35 to 40 iPr vol frac.

### Example 3

### Enhanced Solid-Liquid Separation in Anaerobic Digestate Using Methanol

This experiment demonstrates a step-change at 0.45 methanol volume fraction in which the supernatant total solids increases.

The digestate was obtained from a well-mixed, refrigerated sample bucket (1 of 4). Digestate was mixed with methanol from 5 to 75% volume methanol. Each sample was 40 mL and was prepared by adding methanol to digestate. The weight of digestate and methanol was measured using an analytical balance accurate to 0.1 mg. After vigorous mixing, the samples were centrifuged at 3700 rcf for five minutes in a Thermo Scientific Heraeus Megafuge 40 Centrifuge at 20° C. The supernatant was decanted into a tarred crucible. After weighing the pellet mass, a sample was transferred to a tarred crucible. Crucibles with samples were placed in a forced-air convection oven at 70° C. for 48 hours and the resulting dry weight was measured.

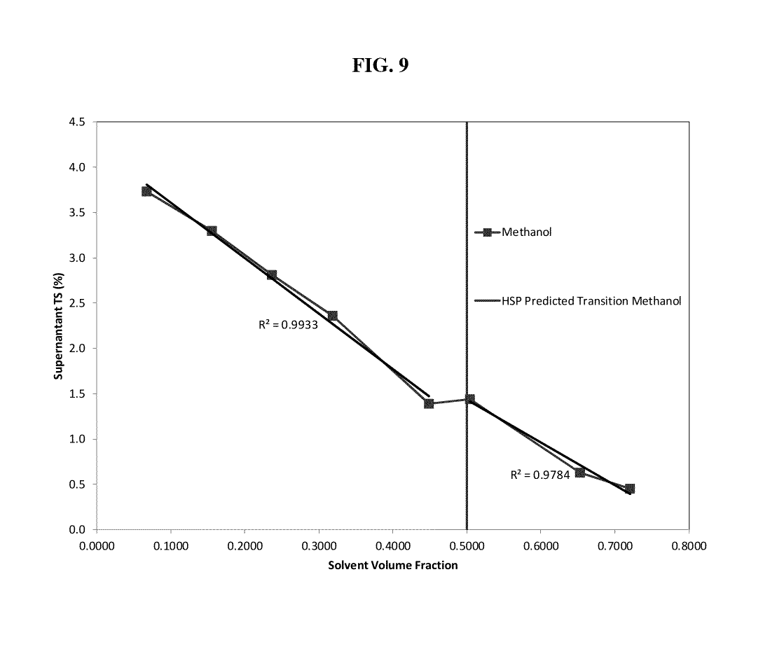

The supernatant TS % for centrifuged methanol/digestate mixtures is given in FIG. 9. The supernatant TS % was measured from the supernatant of the centrifuged methanol/digestate samples for various methanol solvent volume fractions (MeOH vol frac). As the MeOH vol frac increases, there is a linear decrease in supernatant TS % between 0.05 and approximately 0.45 MeOH vol frac. A step change is observed between 0.45 and 0.5 MeOH vol frac with an increase in supernatant TS %. After a 0.5 solvent volume fraction, a linear decrease in supernatant TS % is observed.

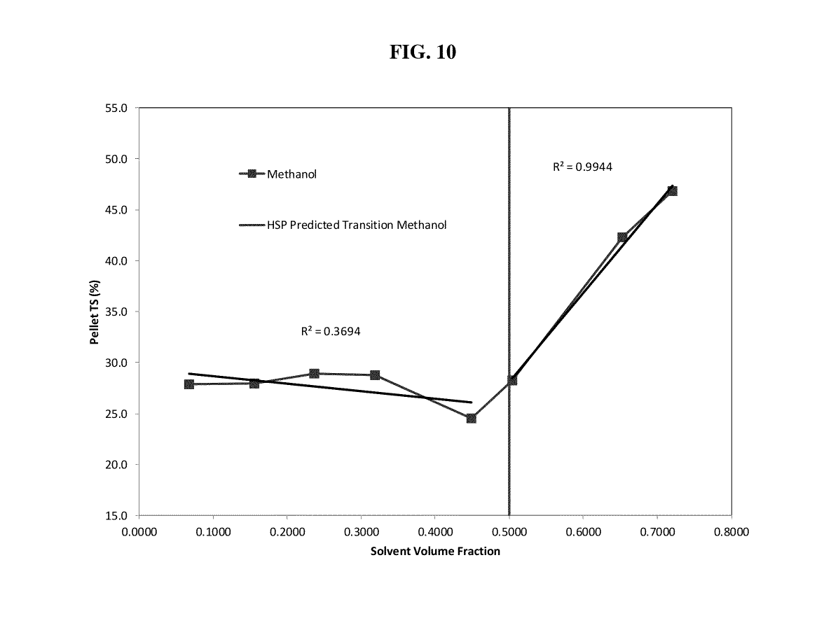

The pellet TS % shown in FIG. 10 was approximately constant between 0.05 and 0.5 MeOH vol frac. There is a linear, sharp increase between 0.5 and 0.75 MeOH vol frac. The increase above 0.5 MeOH vol frac is due to captured solvent in the digestate solids that is not released at 70° C. The amount of residual solvent was not tested.

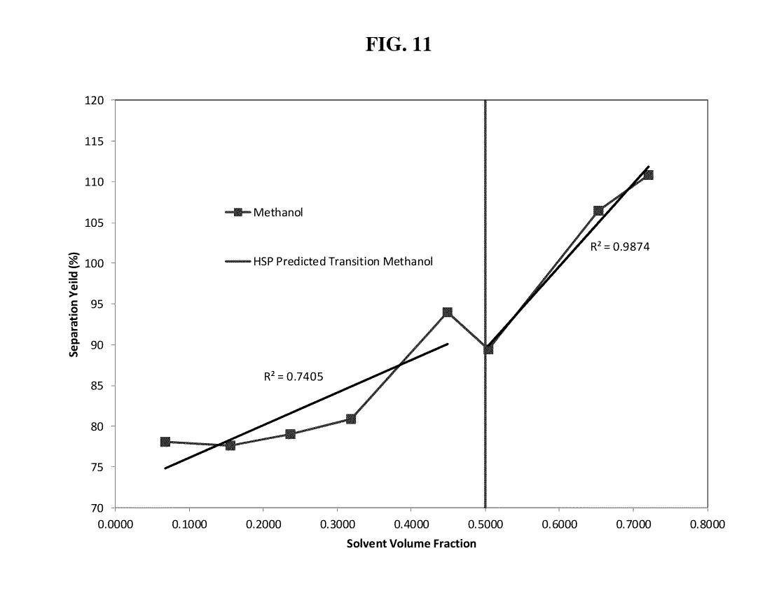

The separation yield percentage (“Separation Yield %”) of solids captured in the pellet (FIG. 11) was calculated as the ratio of dry-basis solids in the pellet to dry-basis solids in the digestate component of the digestate/methanol mixture after centrifugation at 3700 rcf for 5 minutes. The separation yield % is over 100% because 80° C. is not a high enough temperature to make all the methanol dissociate from the digestate solids. There is a concave-up, power function-like increase in separation yield from 0.05 to 0.45 MeOH vol frac. There is a decrease in separation yield at a 0.5 MeOH vol frac and a sharp increase after 0.5 MeOH vol frac. The increase above 0.5 MeOH vol frac is due to bound solvent in the digestate solids rather than more suspended solids being pushed from solution.

### Example 4

### Enhanced Solid-Liquid Separation in Anaerobic Digestate Using Ethanol

This experiment demonstrates a step-change at 0.35 ethanol volume fraction in which the supernatant total solids increases.

For this experiment, digestate was obtained from a well-mixed, refrigerated sample bucket (1 of 4). Each sample was 50 mL and was prepared by adding ethanol to digestate in a 50 mL centrifuge tube at concentrations from 0-75% volume increasing at 5% volume intervals. The weight of the digestate and ethanol was recorded using a scale that is accurate to 0.1 mg. After vigorous mixing, the samples were centrifuged at 3700 rcf for 5 minutes in a Thermo Scientific Heraeus Megafuge 40 Centrifuge at 20° C. After centrifugation, the supernatant was decanted into a tarred crucible. Crucibles with samples were then placed in a forced air oven at 80° C. for 68 hours, and the resulting dry weight was measured.

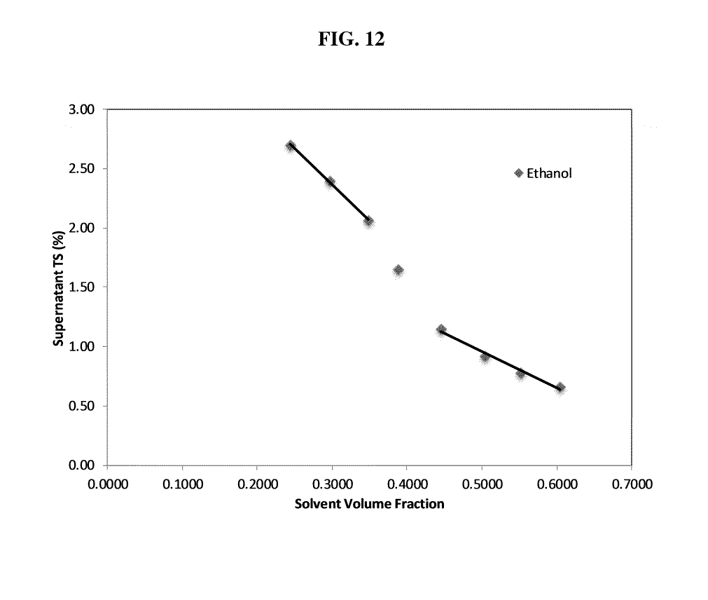

The resulting supernatant TS % for ethanol/digestate mixtures is shown in FIG. 12. The supernatant TS % was measured from the supernatant for various ethanol/digestate solutions at various ethanol solvent volume fraction (EtOH vol frac). There is a linear decrease in supernatant TS % between 0 and approximately 0.25 EtOH vol frac. Between the EtOH vol frac of 0.3 and 0.4 there is a step decrease during which there is a sharp decrease in supernatant TS %. After 0.4 EtOH vol frac there is another linear decrease in supernatant TS %. At the 0.35 EtOH vol frac the supernatant starts to become clear and around 0.5 EtOH vol frac the supernatant becomes a dark yellow color that becomes paler and clearer as the EtOH vol frac increase. The linear decrease in supernatant TS % between 0 to 0.25 and 0.4 to 0.7 EtOH vol frac is the result of dilution.

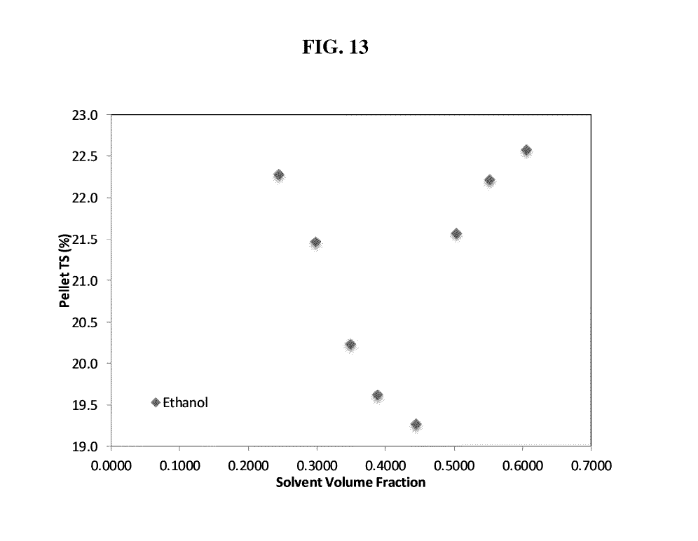

The pellet TS % was measured from the pellet for various ethanol/digestate solutions at various EtOH vol frac and is given in FIG. 13. There is a linear decrease in pellet TS % between 0 and approximately 0.45 EtOH vol frac. Between the EtOH vol frac of 0.45 and 0.5, there is a step decrease during which there is a sharp increase in pellet TS %. After 0.5 EtOH vol frac there is another linear increase in pellet TS %.

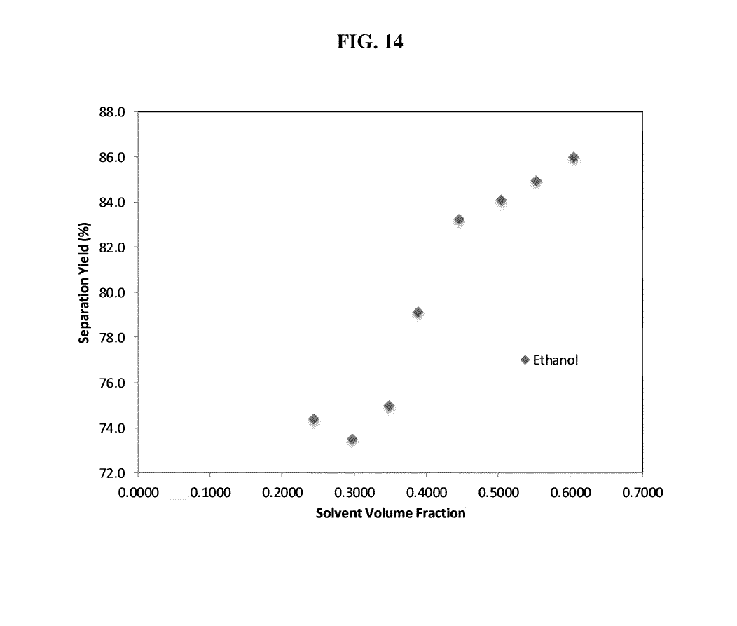

The separation yield is given in FIG. 14 for ethanol/digestate mixtures. The yield is approximately constant from 0.25 to 0.4 EtOH vol frac and step wise increases from 0.4 to 0.5 EtOH vol frac. The yield remains approximately constant above 0.5 EtOH vol frac.

### Example 5

### Enhanced Solid-Liquid Separation in Anaerobic Digestate Using 1-Propanol

The purpose of this experiment was to test how well 1-propanol performed when used to separate digestate at various concentrations.

For this experiment, digestate was obtained from a well-mixed, refrigerated sample bucket (1 of 4). Each sample was 50 mL and was prepared by adding 1-propanol to digestate in a 50 mL centrifuge tube at concentrations from 0-75% 1-propanol increasing at 5% intervals. The weight of the digestate and 1-propanol was recorded using a scale that is accurate to 0.1 mg. After vigorous mixing, the samples were centrifuged at 3700 rcf for 5 minutes in a Thermo Scientific Heraeus Megafuge 40 Centrifuge at 20° C. After centrifugation, the supernatant was decanted into a tarred crucible. Crucibles with samples were then placed in a forced air oven at 80° C. for 68 hours and the resulting dry weight was measured.

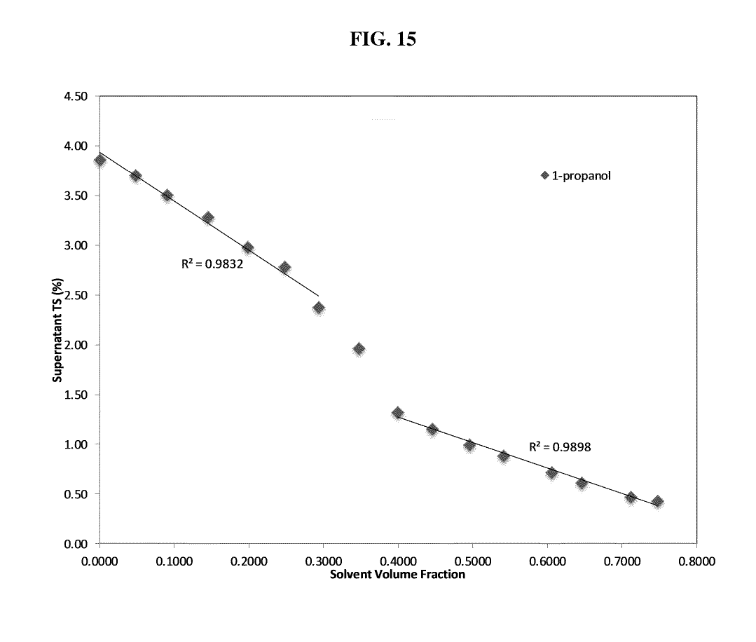

The supernatant TS % is shown in FIG. 15 for various 1-propanol/digestate mixtures. The supernatant TS % was measured from the supernatant for 1-propanol/digestate at various 1-propanol solvent volume fraction (PrOH vol frac). There is a linear decrease in supernatant TS % between 0 and 0.25 PrOH vol frac. Between the PrOH vol frac of 0.3 and 0.4 there is a sharp decrease in supernatant TS %. After 0.4 PrOH vol frac, there is another linear decrease in supernatant TS % that is observed. At the 0.35 PrOH vol frac the supernatant starts to become clear, and around 0.5 PrOH vol frac, the supernatant becomes a dark yellow color that becomes clearer and lighter as the PrOH vol frac increase. The linear decrease in supernatant TS % between 0 to 0.25 and 0.4 to 0.7 PrOH vol frac is the result of dilution.

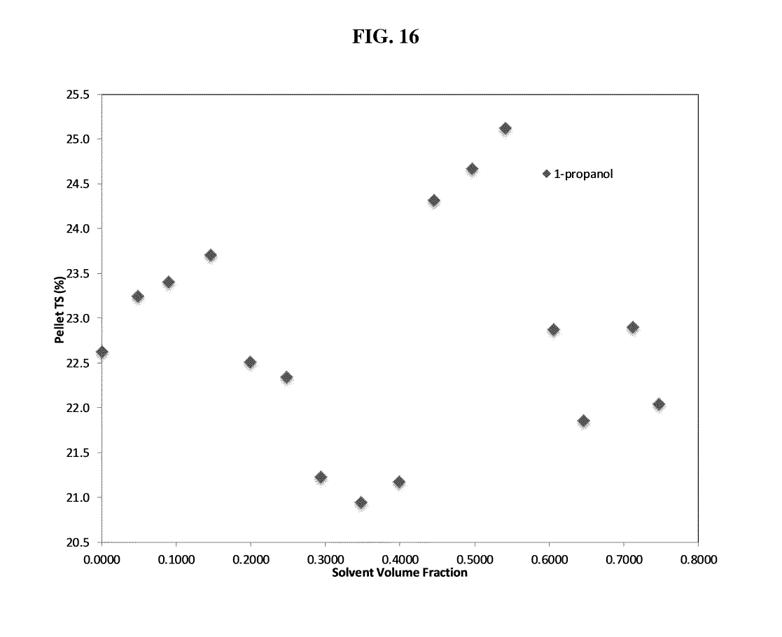

The pellet TS % was measured from the pellet for various 1-propanol/digestate solutions at various PrOH vol frac and is given in FIG. 16. There is a no recognizable relationship in the pellet TS %.

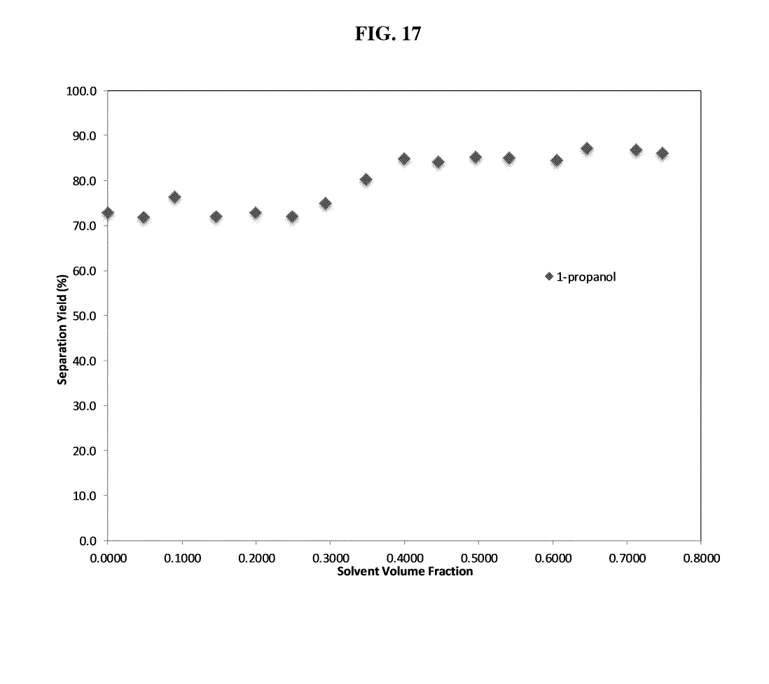

The separation yield is given in FIG. 17 for 1-propanol/digestate mixtures. The yield is approximately constant at 75% from 0 to 0.4 PrOH vol frac and step wise increases from 0.4 to 0.5 PrOH vol frac. The yield remains approximately constant at 85% above 0.5 PrOH vol frac.

### Example 6

### Solid-Liquid Separation in Anaerobic Digestate Using 1-Butanol

The purpose of this experiment was to test how well 1-butanol performed when used to separate digestate at various concentrations.

For this experiment, digestate was obtained from a well-mixed, refrigerated sample bucket (1 of 4). Each sample was 50 mL and was prepared by adding 1-butanol to digestate in a 50 mL centrifuge tube at concentrations from 0-75% increasing at 5% intervals. The weight of the digestate and 1-butanol was recorded using a scale that is accurate to 0.1 mg. After vigorous mixing the samples were centrifuged at 3700 rcf for 5 minutes in a Thermo Scientific Heraeus Megafuge 40 Centrifuge at 20° C. After centrifugation, the supernatant was decanted into a tarred crucible. Crucibles with samples were then placed in a forced air oven at 80° C. for 68 hours, and the resulting dry weight was measured.

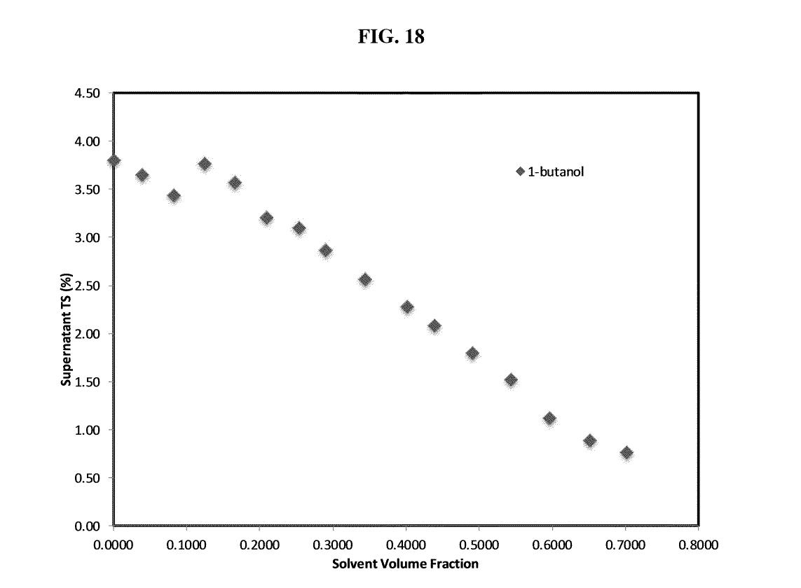

The supernatant TS % is shown in FIG. 18 for 1-butanol/digestate mixtures. The supernatant TS % was measured from the supernatant for various 1-butanol solvent volume fraction (nBuOH vol frac). There is a linear decrease in supernatant TS % from 0 to 0.10 nBuOH vol frac, and then there is a step-wise increase in supernatant TS % at 0.15 nBuOH vol frac followed by a linear decrease. There is apparently no sharp decline in supernatant TS for the 1-butanol. An additional problem with 1-butanol as a solvent, is that it produced two layers of supernatant at no point producing only one layer of clear supernatant. At all concentrations there was a portion of supernatant that was a murky brown. At an approximately 0.1 nBuOH vol frac, there is a thin layer of clear yellow supernatant that increases in volume as the concentration increases.

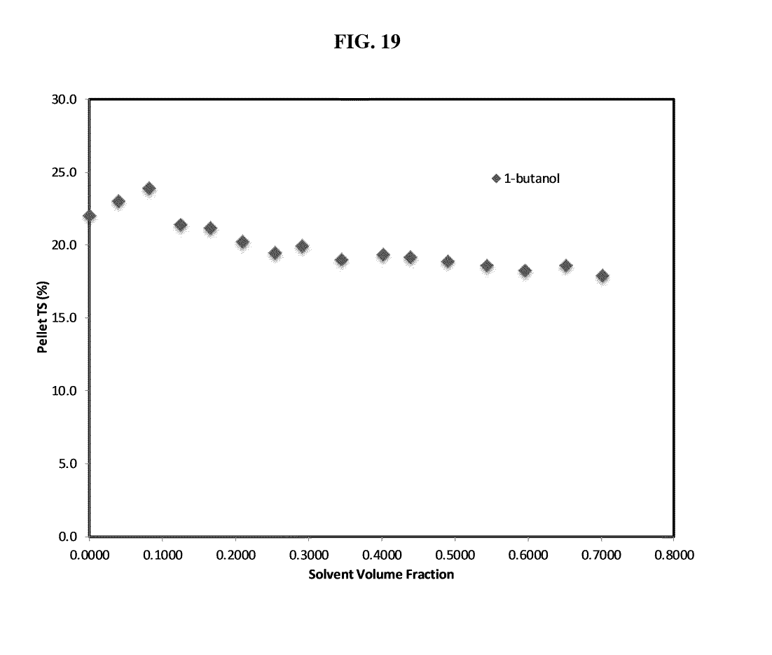

The pellet TS % was measured from the pellet for various 1-butanol/digestate solutions at various nBuOH vol frac and is given in FIG. 19. The pellet TS % increased linearily from 0 to 0.1 nBuOH vol frac. There is step decrease in pellet TS % between 0.1 and 0.15 nBuOH vol frac followed by a linear decrease in pellet TS %.

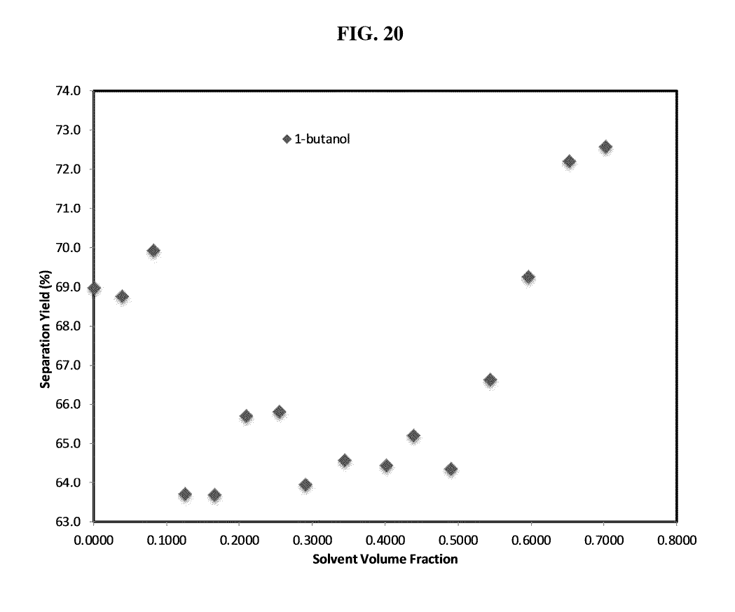

The separation yield is given in FIG. 20 for 1-butanol/digestate mixtures. The yield is approximately parabolic concave up with a minimum at about 0.4 nBuOH vol frac. The maximum yield was 73% above 0.65 nBuOH vol frac.

### Example 7

### Solid-Liquid Separation in Anaerobic Digestate Using 2-Butanol

The purpose of this experiment was to test how well 2-butanol performed when used to separate digestate at various concentrations.

For this experiment, digestate was obtained from a well-mixed, refrigerated sample bucket (1 of 4). Each sample was 50 mL and was prepared by adding 2-butanol to digestate in a 50 mL centrifuge tube at concentrations from 0-75% increasing at 5% intervals. The weight of the digestate and 2-butanol was recorded using a scale that is accurate to 0.1 mg. After vigorous mixing, the samples were centrifuged at 3700 rcf for 5 minutes in a Thermo Scientific Heraeus Megafuge 40 Centrifuge at 20° C. After centrifugation, the supernatant was decanted into a tarred crucible. Crucibles with samples were then placed in a forced air oven at 80° C. for 68 hours and the resulting dry weight was measured.

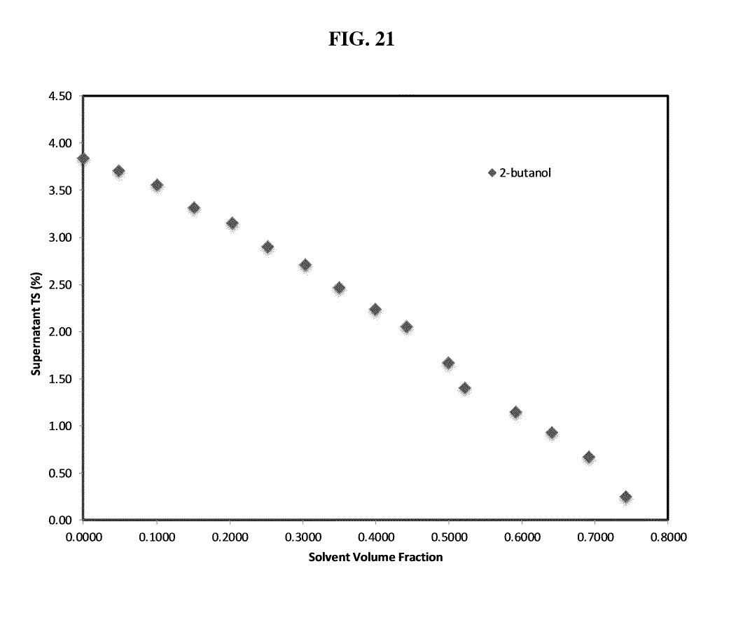

The supernatant TS % for 2-butanol/digestate mixtures is shown in FIG. 21. The supernatant total solid (TS) % was measured from the supernatant for various 2-butanol solvent volume fraction (iBuOH vol frac). The 2-butanol produces a linear decrease in the supernatant TS % for all values of iBuOH vol frac. There is apparently no step change, or sharp decline in supernatant TS % for the 2-butanol. At all concentrations, there was a portion of supernatant that was a murky brown. A layer of clear yellow supernatant first appeared at approximately 0.15 iBuOH vol frac as a very thin layer and remained throughout the experiment increasing in volume and increased in volume to become approximately 45 mL.

In conclusion the 2-butanol was mixed with digestate and was mixed vigorously before being centrifuged for 5 minutes at 3700 rcf. Since at no concentration does the 2-butanol produce a single clear supernatant, it would have to be mixed with isopropanol to provide this result.

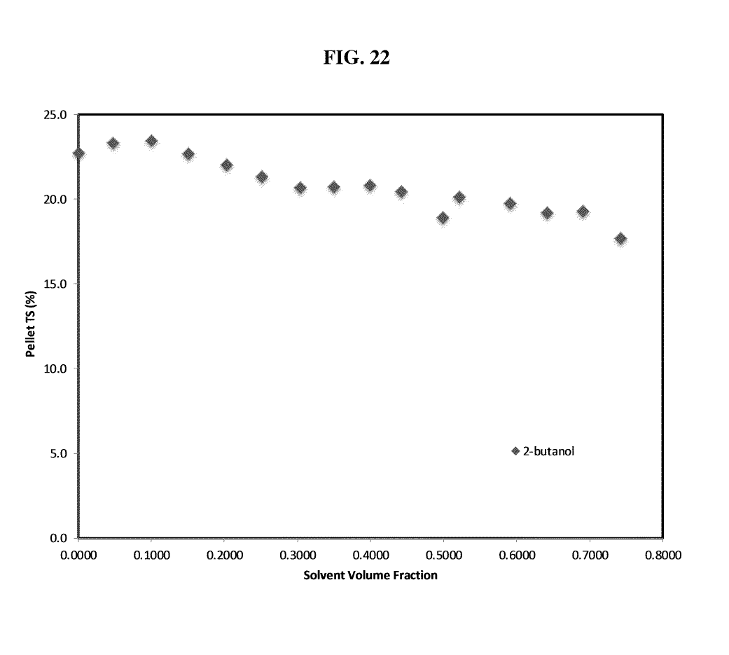

The pellet TS % was measured from the pellet for various 2-butanol/digestate solutions at various iBuOH vol frac and is given in FIG. 22. The pellet TS % decreased linearly for all iBuOH vol frac.

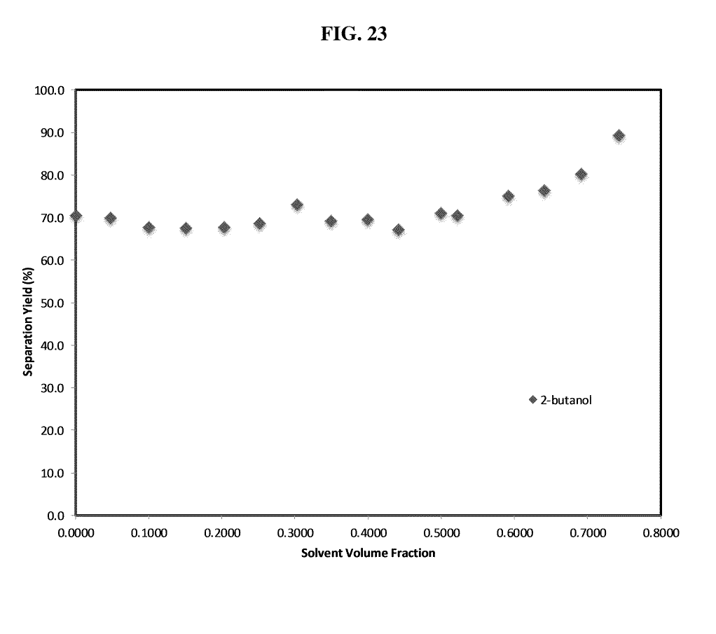

The separation yield is given in FIG. 23 for 2-butanol/digestate mixtures. The yield is approximately constant at 70% for all iBuOH vol frac.

### Example 8

### Enhanced Solid-Liquid Separation in Anaerobic Digestate Using 1-Pentanol

This experiment demonstrates a step-change at 0.35 1-pentanol volume fraction in which the two phase supernatant total solids decreases. Digestate was mixed with 1-pentanol from 5 to 75% volume 1-pentanol. Each sample was 40 mL and was prepared by adding 1-pentanol to the sample. The weight of digestate and 1-pentanol was measured using an analytical balance accurate to 0.1 mg. After vigorous mixing, the samples were centrifuged at 3700 rcf for five minutes in a Thermo Scientific Heraeus Megafuge 40 Centrifuge at 20° C. The supernatant was decanted into a tarred crucible. After weighing the pellet mass, a sample was transferred to a tarred crucible. Crucibles with samples were placed in a forced-air convection oven at 70° C. for 48 hours, and the resulting dry weight was measured.

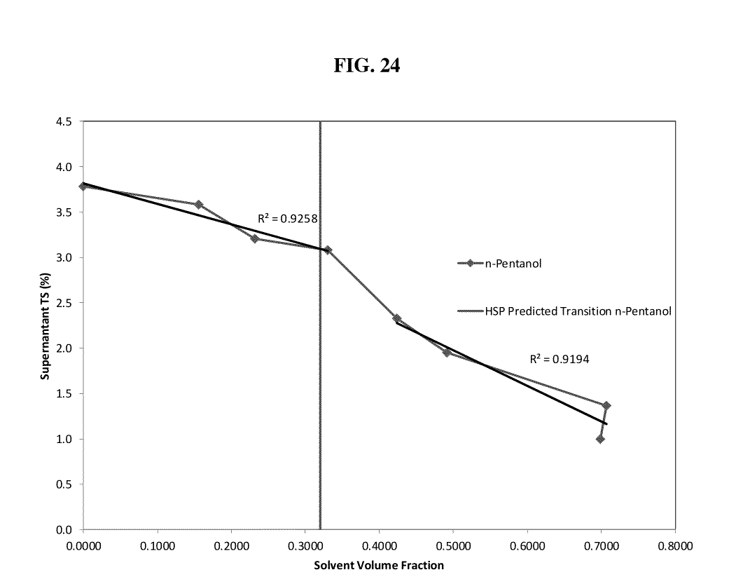

The supernatant TS % for centrifuged 1-pentanol/digestate mixtures is given in FIG. 24. The supernatant total solid (TS) % was measured from the supernatant of the centrifuged 1-pentanol/digestate samples for various 1-pentanol solvent volume fractions (PeOH vol frac). As the PeOH vol frac increases, there is a linear decrease in supernatant TS % between 0.05 and approximately 0.35 PeOH vol frac. A step change is observed between 0.35 and 0.4 PeOH vol frac with a decrease in supernatant TS %. After a 0.4 PeOH vol frac, a linear decrease in supernatant TS % is observed.

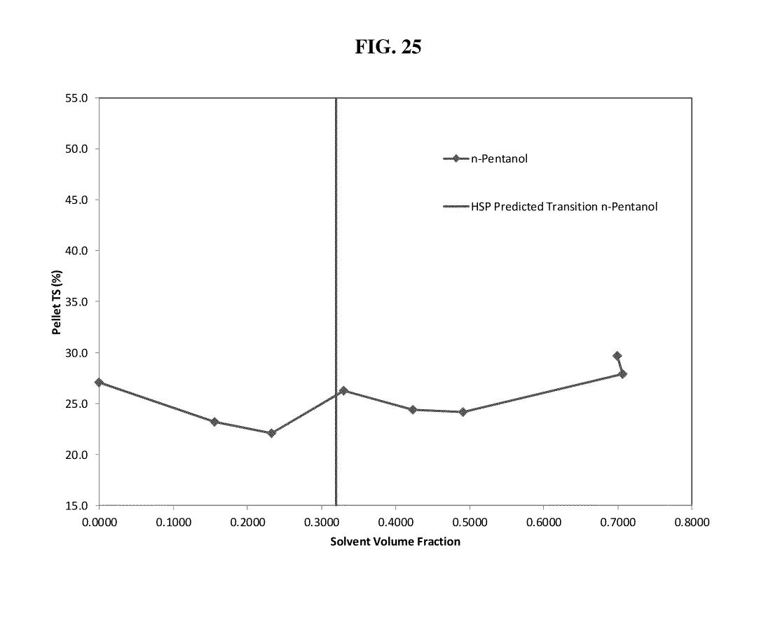

The pellet TS % shown in FIG. 25 was approximately constant at 25% for all PeOH vol frac.

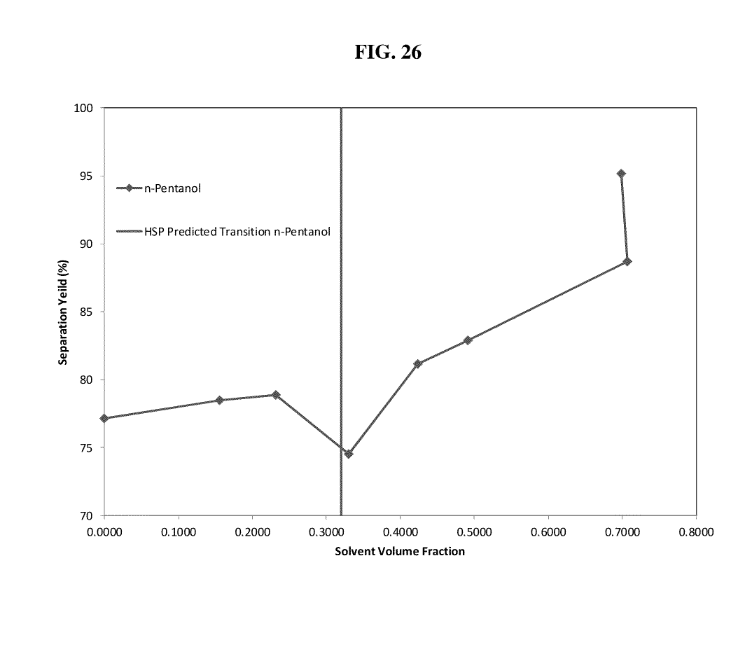

The separation yield percentage of solids captured in the pellet (FIG. 26) was calculated as the ratio of dry-basis solids in the pellet to dry-basis solids in the digestate component of the digestate/1-pentanol mixture after centrifugation at 3700 rcf for 5 minutes. There is an approximately constant yield of 75% from 0.05 to 0.35 PeOH vol frac. There is an approximately linear increase in separation yield at above 0.4 PeOH vol frac reaching a maximum of 90-95%.

### Example 9

### Ethyl Acetate/Isopropanol

The purpose of this experiment was to test how well ethyl acetate/isopropanol mixtures performed when used to separate digestate at various concentrations.

For this experiment, digestate was obtained from a well-mixed, refrigerated sample bucket (1 of 4). Ethyl acetate solution (EtAcSoln) was prepared by mixing 400 mL of ethyl acetate with 600 mL of isopropanol. Each sample was 50 mL and was prepared by adding EtAcSoln to digestate in a 50 mL centrifuge tube at concentrations from 0-75% EtAcSoln increasing at 5% intervals. The weight of the digestate and EtAcSoln was recorded using a scale that is accurate to 0.1 mg. After vigorous mixing the samples were centrifuged at 3700 rcf for 5 minutes in a Thermo Scientific Heraeus Megafuge 40 Centrifuge at 20° C. After centrifugation, the supernatant was decanted into a tarred crucible. Crucibles with samples were then placed in a forced air oven at 80° C. for 68 hours and the resulting dry weight was measured.

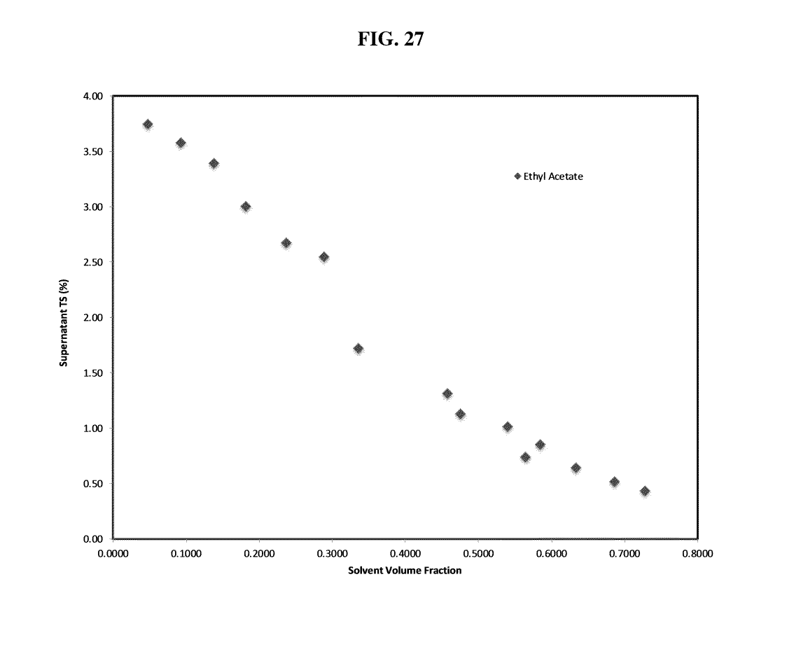

The supernatant TS % is shown in FIG. 27 for EtAcSoln/digestate mixtures. The supernatant TS % was measured from the supernatant for various EtAcSoln solvent volume fraction (EtAcSoln vol frac). The ethyl acetate produced a linear decrease in supernatant TS % between 0 and 0.275 EtAcSoln vol frac. There was an unexpected decrease in supernatant TS % that is sharper than pure isopropanol between 0.275 and 0.3 EtAcSoln vol frac. After 0.3 EtAcSoln vol frac, the supernatant TS % decreases linearly.

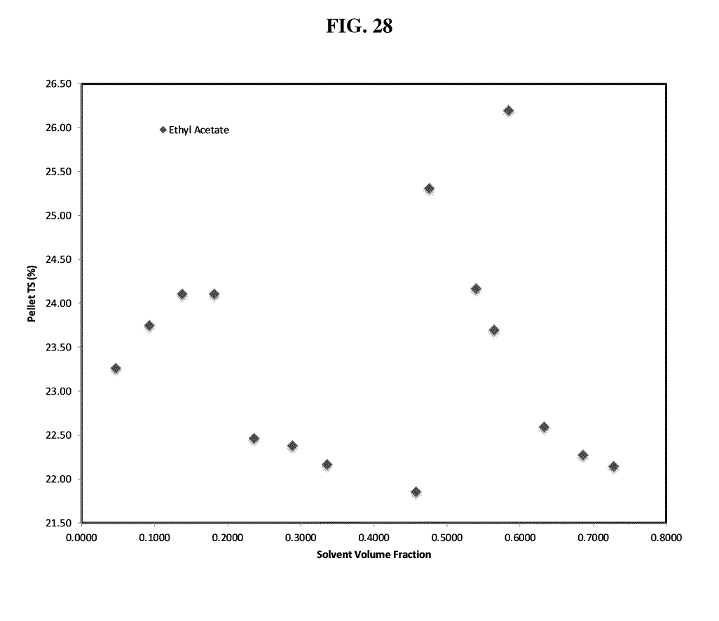

The pellet TS % shown in FIG. 28 is highly variable for 60% isopropanol/40% ethyl acetate mixtures with digestate. There is a linear increase in pellet TS % from 0.05 to 0.2 EtAcSoln vol frac. There is a step function decrease at 0.25 EtAcSoln vol frac followed by a linear decrease in pellet TS % from 0.25 to 0.45 EtAcSoln vol frac. There is a step function increase in pellet TS % at 0.5 EtAcSoln vol frac followed by a linear decrease in pellet TS % above 0.5 EtAcSoln vol frac.

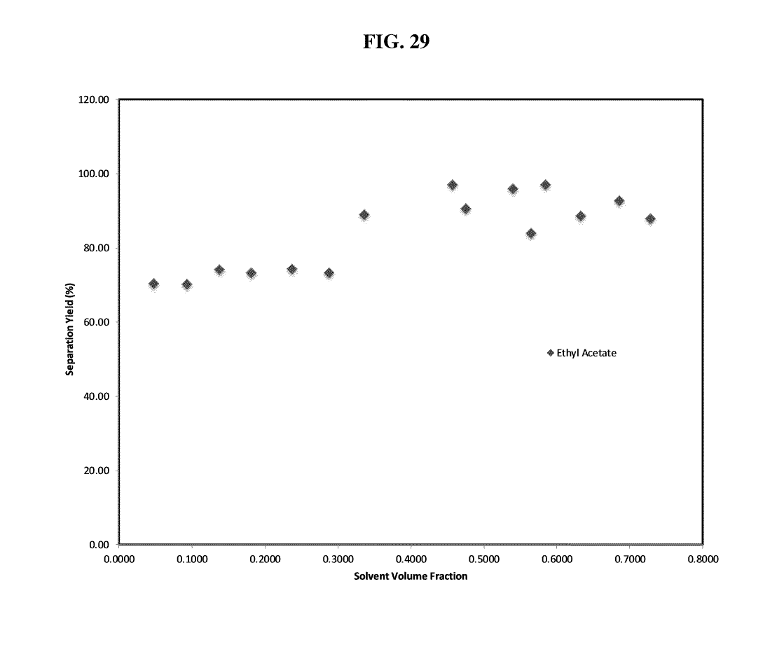

The separation yield percentage of solids captured in the pellet (FIG. 29) was calculated as the ratio of dry-basis solids in the pellet to dry-basis solids in the digestate component of the digestate/EtAcSoln mixture after centrifugation at 3700 rcf for 5 minutes. There is an approximately constant yield of 70% from 0.05 to 0.3 EtAcSoln vol frac. There is a step increase in separation yield percentage at 0.35 EtAcSoln vol frac. The separation yield is constant at 90% above 0.35 EtAcSoln vol frac.

### Example 10

### Water Dilution (No Separation)

The purpose of this experiment was to demonstrate the water/digestate mixtures did not separated due to some dilution effect.

Digestate was obtained from a well-mixed, refrigerated sample bucket (1 of 4). Each sample was 40 mL and was prepared by adding water to digestate in a 50 mL centrifuge tube at concentrations from 0-75% volume water increasing at 5% intervals. The weight of the digestate and water was recorded using a scale that is accurate to 0.1 mg. After vigorous mixing, the samples were centrifuged at 3700 rcf for 5 minutes in a Thermo Scientific Heraeus Megafuge 40 Centrifuge at 20° C. After centrifugation, the supernatant was decanted into a tarred crucible. Crucibles with samples were then placed in a forced air oven at 80° C. for 70 hours and the resulting dry weight was measured.

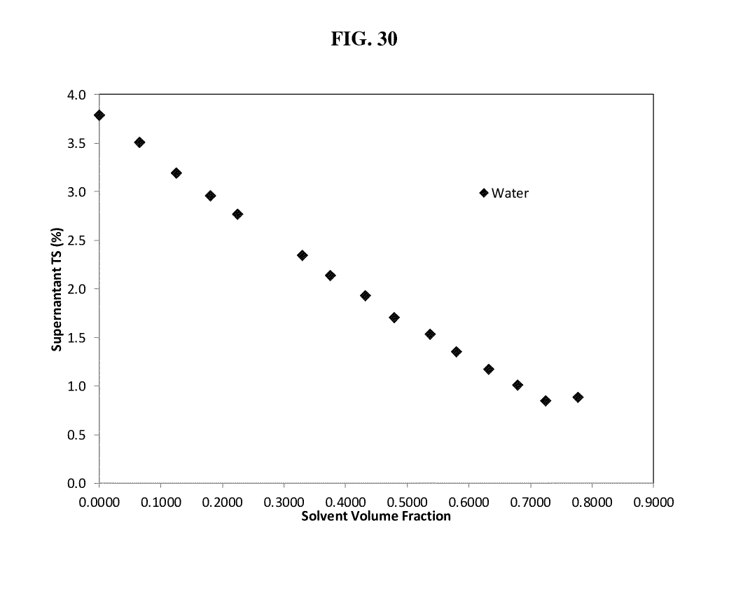

The supernatant TS % is shown in FIG. 30 for water/digestate mixtures. The supernatant TS % was measured from the supernatant for various water solvent volume fraction (H2O vol frac). The water produced a linear decrease in supernatant TS % for all H₂O vol frac. Comparison of a new solvent's separation efficacy should be conducted by comparing the supernatant TS % of the solvent with the above water supernatant TS %. A negative efficacy results for any solvent tested in which the supernatant TS % is the same or higher than water.

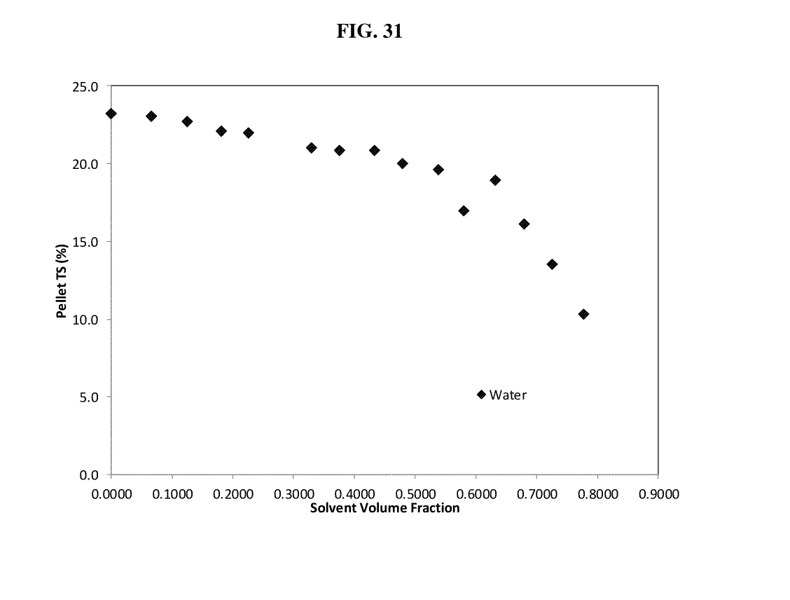

The pellet TS % for water/digestate mixtures is shown in FIG. 31, and decreases linearly until approximately 0.65 H₂O vol frac. After 0.65 H₂O vol frac, there is a linear decrease with a more negative slope than before.

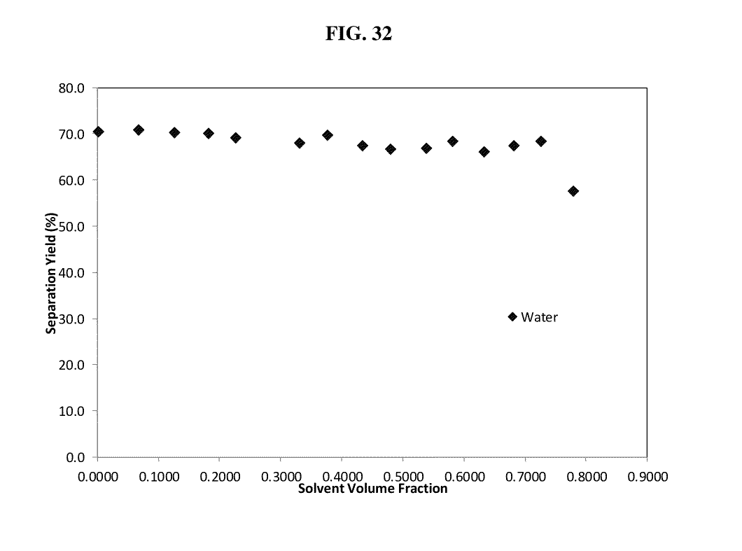

The separation yield percentage of solids captured in the pellet (FIG. 32) was calculated as the ratio of dry-basis solids in the pellet to dry-basis solids in the digestate component of the digestate/water mixture after centrifugation at 3700 rcf for 5 minutes. There is an approximately constant yield of 70% for all H₂O vol frac.

### Example 11

### Pure Isopropanol Vs. Recovered Isopropanol

This experiment demonstrates that 80% isopropanol/water separates digestate in a similar fashion as pure isopropanol, with a step-change at 0.35 isopropanol volume fraction (0.45 solvent volume fraction) in which the supernatant total solids increases.

Digestate was mixed with 80% isopropanol from 0 to 75% volume of 80% isopropanol. Each sample was 40 mL and was prepared by adding methanol to digestate. The weight of digestate and isopropanol was measured using an analytical balance accurate to 0.1 mg. After vigorous mixing, the samples were centrifuged at 3700 rcf for five minutes in a Thermo Scientific Heraeus Megafuge 40 Centrifuge at 20° C. The supernatant was decanted into a tarred crucible. After weighing the pellet mass, a sample was transferred to a tarred crucible. Crucibles with samples were placed in a forced-air convection oven at 70° C. for 48 hours and the resulting dry weight was measured.

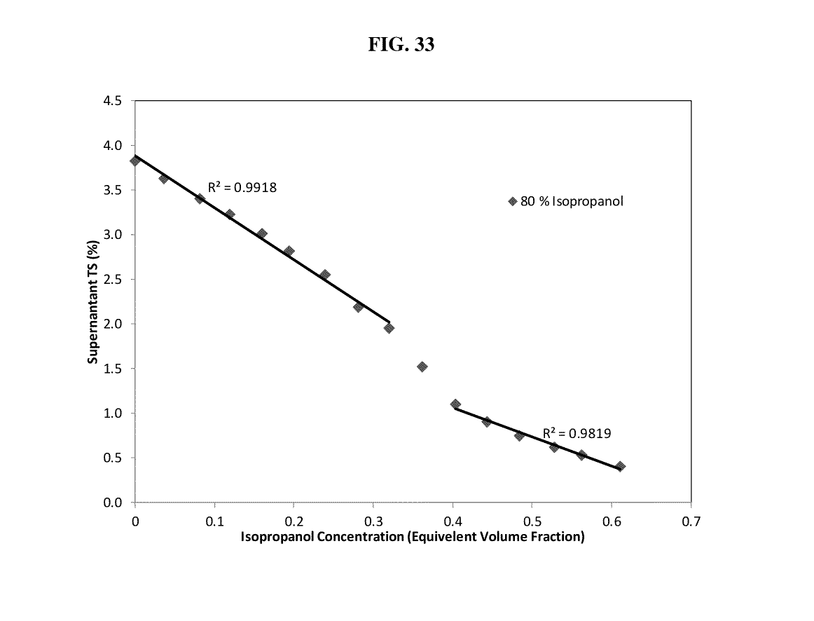

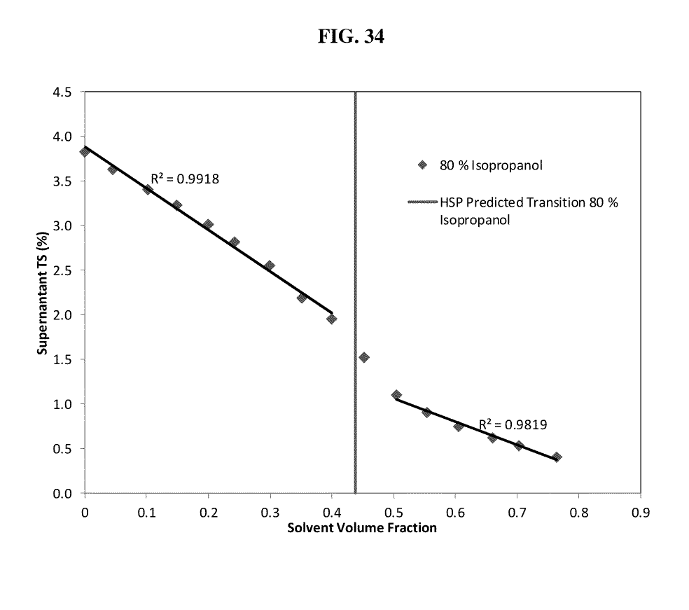

The supernatant TS % for centrifuged 80% isopropanol/digestate mixtures is given in FIG. 33 with the calculated isopropanol concentration displayed as isopropanol volume fraction. FIG. 34 contains the supernatant TS % for centrifuged 80% isopropanol/digestate mixtures with the measured amount of 80% isopropanol displayed as solvent volume fraction. The supernatant TS % was measured from the supernatant of the centrifuged 80% isopropanol/digestate samples for various 80% isopropanol volume fractions (80iPr vol frac). As the 80iPr vol frac increases, there is a linear decrease in supernatant TS % between 0 and 0.4 80iPr vol frac (which correlates to between 0 and 0.325 equivalent pure isopropanol volume fraction). A step change is observed between 0.4 and 0.5 80iPr vol frac (which correlates to between 0.325 and 0.4 equivalent pure isopropanol volume fraction) with a decrease in supernatant TS %. After a 0.5 80iPr vol frac (0.4 equivalent pure isopropanol volume fraction), a linear decrease in supernatant TS % is observed. This confirms that recycled, impure isopropanol can separate digestate in a similar manner to pure isopropanol.

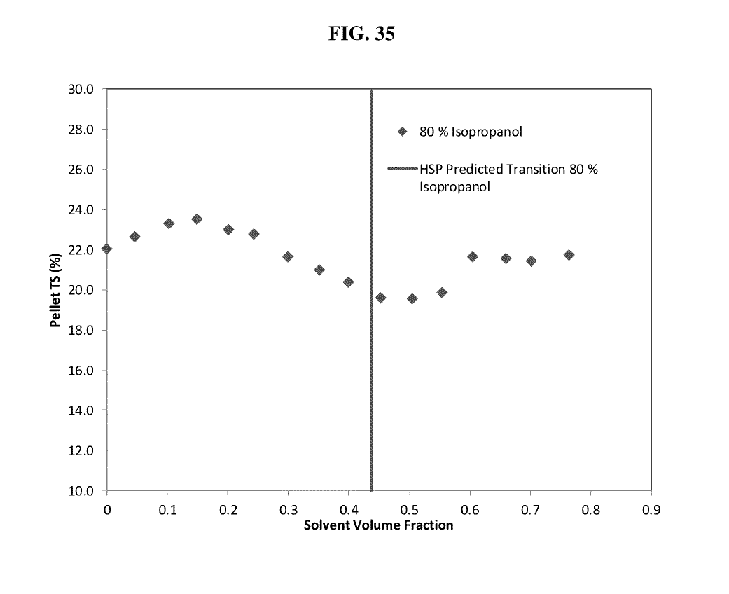

The pellet TS % shown in FIG. 35 was approximately constant at about 21% for all 80iPr vol frac.

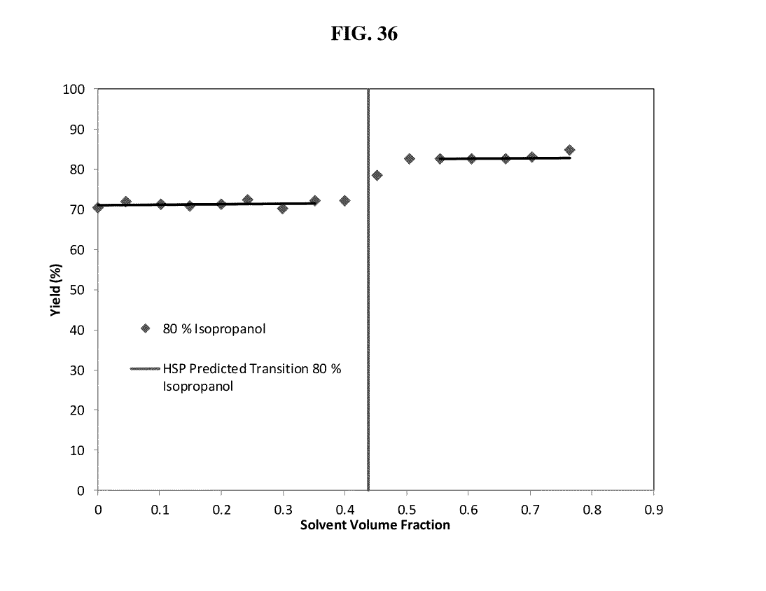

FIG. 36 shows the separation yield of solids captured in the pellet which was calculated as the ratio of dry-basis solids in the pellet to dry-basis solids in the digestate component of the digestate/80% isopropanol mixture after centrifugation at 3700 rcf for 5 minutes. There is an approximately constant yield of 70% between 0 and 0.4 solvent volume fraction and an approximately constant yield of approximately 80% after 0.5 solvent volume fraction with a stepwise increase in yield between 0.4 and 0.5 solvent volume fraction.

1. A method of enhancing solid-liquid separation, comprising:
(1) adding a C1-C5 (e.g., a C1-C3, preferably C3) alcohol to a solid-liquid composition to achieve a final alcohol percentage of about 20-45% (w/w) or about 25-50% (v/v);
(2) mixing the alcohol and the solid-liquid composition to form a mixture;
(3) separating liquid from solid in the mixture.

2. The method of claim 1, wherein the solid-liquid composition comprises at least about 30%, 40%, 50%, 60%, 70%, 80%, 90%, 95% water.

3. The method of claim 1, wherein the solid-liquid composition comprises dissolved solid.

4. The method of claim 1, wherein the solid-liquid composition is anaerobic digestate or a fraction thereof (e.g., a mechanically/screw press-separated digestate fraction), silt, or oil sands tailings (e.g., mature fine tailing or CT overflow).

5. The method of claim 1, wherein the low molecular weight alcohol is dissolved or dispersed in a liquid (90% or 80% recycled isopropanol, 95% ethanol, etc.).

6. The method of claim 1, wherein the C1-C3 alcohol is methanol, ethanol, 1-propanol, isopropanol, or a mixture thereof.

7. The method of claim 1, wherein in step (1), the C1-C3 alcohol is isopropanol, and the final alcohol percentage is about 30-40% (v/v), about 35% (v/v), about 25-35% (w/w), or about 30% (w/w).

8. The method of claim 1, wherein step (2) is carried out by vortexing, vigorous shaking, or stirring.

9. The method of claim 1, wherein step (3) is carried out by centrifugation (e.g., about 3500-4000 rcf for 5 min).

10. The method of claim 1, further comprising:
(4) recovering at least a portion of the alcohol after step (3).

11. The method of claim 10, further comprising:
(5) recycling at least a portion of the alcohol recovered in step (4) for use in step (1).

12. The method of claim 1, wherein the solid-liquid composition is mature fine tailing (MTF), and wherein bitumen is recovered.

13. A method of extracting petroleum from bituminous sands, comprising:
(1) using a water-requiring extraction method, extracting petroleum from bituminous sands, and producing petroleum and an aqueous sludge by-product; and,
(2) using the method of claim 1, dewatering the aqueous sludge by-product to produce recycled water and a solid sediment.

14. The method of claim 13, further comprising:
(3) re-using the recycled water from step (2) in step (1).

15. The method of claim 14, further comprising depositing the solid sediment in a landfill.
